(19) United States
(12) Patent Application Publication
(10) Pub. No.: US 2024/0020433 A1
(43) Pub. Date: Jan. 18, 2024

(54) METHOD TO PREDICT MECHANICAL PROPERTIES OF STACKED PARTICLE MATS

(71) Applicant: BASF SE, Ludwigshafen (DE)

(72) Inventors: Claudia Gisela CORDES, Lemfoerde (DE); Florian NIEDERHOEFER, Dautphetal (DE)

(21) Appl. No.: 18/255,439

(22) PCT Filed: Dec. 14, 2021
(86) PCT No.: PCT/EP2021/085678

§ 371 Date: Jun. 1, 2023

(30) Foreign Application Priority Data
Dec. 15, 2020 (EP) 20214050.5

(51) Int. Cl. G06F 30/17; G06F 30/23; G06F 30/27

(52) U.S. Cl. CPC G06F 30/17; G06F 30/23; G06F 30/27

(57) ABSTRACT

Disclosed herein is a computer implemented method for predicting at least one mechanical property of at least one composite element including at least two layers. The method includes:
a) providing at least one input parameter set, where the input parameter set includes a plurality of parameters defining properties of each of the single layers;
b) determining at least one geometric model of the composite element based on the input parameter set using at least one design tool; and
c) determining at least one mechanical property of the geometric model of the composite element by using at least one numerical simulation, where the mechanical property includes one or more of tension property, pressure property, shear property, temperature property, and a combination thereof.

### TECHNICAL FIELD

The invention relates to a computer-implemented method for predicting at least one mechanical property of at least one composite element, a computer implemented method for determining a layout of at least one composite element, computer programs, computer-readable storage media, automated control system and an automated layout designing system. The invention specifically may be used for chemical manufacturing and industrial production of composite elements.

### BACKGROUND ART

In many application fields, for example, in the field of sport articles such as footwear, a strong demand exists for high performance materials, which should be superior in their mechanical properties. Especially footwear materials are required having low densities, resulting in low weight, in combination with high elasticity and further improved mechanical properties. An important aspect is damping, i.e. the ability of a material to reduce impact forces and rebound resilience. Currently elastomeric foams are used for production of high performance shoe soles. However, the known foam materials generally have an upper limitation in beneficial performance like, for example, energy return since continuous reduction of foam density generally results in unfavorable reduction of energy return. Thus, a continuous enhancement of energy return of low density final articles made from elastic foam materials is an important challenge.

WO 2018/172287 describes the use of a composite element for a shoe sole, wherein the composite element comprises at least two elements, wherein each element has a body, a longitudinal extension and a height h vertical to the longitudinal extension and comprises a polymeric material with a cellular structure, wherein the elements are at least one partial contact parallel to the longitudinal extension and have a closed surface (skin) at least in the contact area.

WO 2015/105859 A1 describes a unit cell that has a cellular geometry that comprises cell walls and cell edges arranged into a combination of a cubic cell geometry and a tetrahedral cell geometry and assembled structures that comprise a plurality of unit cells. The voids of the unit cell created by the combination of geometries comprise regular tetrahedrons, irregular tetrahedrons, and octahedrons. WO 2019/068032 A1 describes intraoral appliances with adaptive cellular materials and structures.

The optimal design of particle mats, however, depends on a plurality of factors and applications. Generally, development of new design requires for each adaption or amendment of the design new mold inlays, which results in high costs. Therefore, there is a need for a tool configured for predicting properties of the particle mats in order to find the optimal design for given applications.

### Problem to be Solved

It is therefore desirable to provide methods and devices which address the above-mentioned technical challenges. Specifically, devices and methods for predicting at least one mechanical property of at least one composite element shall be provided which allow finding an optimal design of a composite element.

### SUMMARY

This problem is addressed by a computer-implemented method for predicting at least one mechanical property of at least one composite element, a computer implemented method for determining a layout of at least one composite element, computer programs, computer-readable storage media, automated control system and an automated layout designing system with the features of the independent claims. Advantageous embodiments which might be realized in an isolated fashion or in any arbitrary combinations are listed in the dependent claims.

In a first aspect of the present invention, a computer implemented method for predicting at least one mechanical property of at least one composite element comprising at least two layers is proposed.

The term “computer-implemented” as used herein is a broad term and is to be given its ordinary and customary meaning to a person of ordinary skill in the art and is not to be limited to a special or customized meaning. The term specifically may refer, without limitation, to a process which is fully or partially implemented by using a data processing means, such as data processing means comprising at least one processor. The term “computer”, thus, may generally refer to a device or to a combination or network of devices having at least one data processing means such as at least one processor. The computer, additionally, may comprise one or more further components, such as at least one of a data storage device, an electronic interface or a human-machine interface.

The term “processor”, also denoted “processing unit” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. In particular, the processor may be configured for processing basic instructions that drive the computer or system. As an example, the processor may comprise at least one arithmetic logic unit (ALU), at least one floating-point unit (FPU), such as a math coprocessor or a numeric coprocessor, a plurality of registers, specifically registers configured for supplying operands to the ALU and storing results of operations, and a memory, such as an L1 and L2 cache memory. In particular, the processor may be a multicore processor. Specifically, the processor may be or may comprise a central processing unit (CPU). Additionally or alternatively, the processor may be or may comprise a microprocessor, thus specifically the processor's elements may be contained in one single integrated circuitry (IC) chip. Additionally or alternatively, the processor may be or may comprise one or more application specific integrated circuits (ASICs) and/or one or more field-programmable gate arrays (FPGAs) or the like.

The term “composite element” as used herein is a broad term and is to be given its ordinary and customary meaning to a person of ordinary skill in the art and is not to be limited to a special or customized meaning. The term specifically may refer, without limitation, to an element comprising two or more sub-elements. In principle, no restrictions exist regarding the number of sub-elements comprised by one composite element, provided that there are at least two elements present. Preferably, the composite element comprises at least three elements, more preferably from 3 to 10 elements.

In principle, no restrictions exist regarding the dimensions of the composite element, in particular, no restrictions exist regarding a height H of the composite element vertical to each element's longitudinal extension. Preferably, the composite element has a height H vertical to each element's longitudinal extension, which is in the range of from 1 to 10000 mm, more preferably in the range of from 5 to 1000 mm, more preferably in the range of from 5 to 100 mm.

The composite element comprises at least two layers. The term “layer” as used herein is a broad term and is to be given its ordinary and customary meaning to a person of ordinary skill in the art and is not to be limited to a special or customized meaning. The term specifically may refer, without limitation, to an individual element of the composite element. The terms “single layer” and “individual layer” are used synonymous in the following. Specifically, the layers may be or may comprise mats. Each layer has a volume, a longitudinal extension and a maximum height h vertical to the longitudinal extension. In principle, also no restrictions exist regarding the dimensions of each layer, provided that the dimensions of the composite element are defined by the dimensions of the individual layers. For example, a sum of the individual dimensions of each layer may be equal to the dimensions of the composite element. However, in case of interlocked or engaged layers, the height of the composite element may be lower than the height of the individual layers. The layers may have equal dimensions or different dimensions. For example, the composite element may have a pyramidal layer structure with increasing longitudinal extensions of the layers from up to down. Preferably, each layer's height h is in the range of from 0.25 to 2500 mm, more preferably in the range of from 0.5 to 250 mm, more preferably in the range of from 0.75 to 250 mm, more preferably in the range of from 1 to 25 mm.

The layers are stacked. Specifically, in a direction vertical to the longitudinal extension the layers may be arranged one above the other. The layers may be at least in partial contact, for example parallel to the longitudinal extension. In principle, no restrictions exist regarding the adhesion between the individual layers as long as the layers are fixed together. Thus, adhesion between the individual layers may simply be based on mechanical or electrostatic adhesion. Preferably, the layers of the composite element are adhesively bonded in a contact area, preferably by a method selected from the group consisting of stitching, steam-chest molding, gluing and others.

The layers may have a closed surface (skin) at least in a contact area. “Closed surface at least in the contact area” means that each layer has a skin at least in the contact area with its adjacent element, however, each layer's surface may be closed or open in non-contact areas, for example, in case of plate like layers, which are in contact over their larger surfaces, the sides, i.e. the smaller surfaces, where no contact with an adjacent element is given, may display open pores or may equally display a closed surface.

Each layer comprises a network having repeating units which comprise nodes and edges. The term “network” as used herein is a broad term and is to be given its ordinary and customary meaning to a person of ordinary skill in the art and is not to be limited to a special or customized meaning. The term specifically may refer, without limitation, to a system with linked sub-units. In particular, the term network may refer to a structured layer. Each whole individual layer may be regarded as network comprising nodes and edges. Each layer may comprise a plurality of nodes. The nodes of each layer may be arranged within the same plane. Each of the layers may comprise holes or a thin membrane in a plane of the layer between the nodes, wherein the nodes are connected via edges. The network may be or comprise a pattern, in particular a regular pattern, in which the nodes and edges are arranged.

The term “node” as used herein is a broad term and is to be given its ordinary and customary meaning to a person of ordinary skill in the art and is not to be limited to a special or customized meaning. The term specifically may refer, without limitation, to a volume range of the layer having an increased thickness in comparison to regions of holes, membranes or edges. The term node may refer to a particle and/or a vertex. The edges may have a lower thickness compared to the nodes. Holes may have a thickness of zero. Each node may have a shape such as a spherical shape, bipyramidal shape, cuboid shape, or a 3D polygonal shape. The nodes of the at least two layers and/or the nodes of the individual layers may be identical or different. Each node may have a symmetric shape with respect to a plane of the layer. However, non-symmetric designs may be possible, too. For example, nodes and edges may be arranged in different planes of symmetry. Thus, parts of the individual nodes below a plane of symmetry of the edges may be smaller compared to parts of nodes above the plane of symmetry of the edges, or vice versa. Embodiments, wherein parts of the individual nodes below a plane of symmetry of the edges are smaller compared to parts of nodes above the plane of symmetry of the edges, may be advantageous for foaming processes at lower densities. In principle, no restrictions exist regarding the dimensions of the nodes are given. For example, the nodes may have an effective diameter of 0.002 m to 0.1 m. The nodes may have a length, i.e. extension in longitudinal extension of the layer, and a thickness, i.e. extension vertical to the longitudinal extension of the layer. The structure of the network may be defined by the position of the nodes in the network. A relation of numbers of nodes and edges may be from 1:1 to 1:3. Height- proportions of edges and nodes may be from 1:2 to 1:10. Length-proportions of edges and nodes may be arbitrary, preferably from 1:10 to 5:1, more preferably from 1:10 to 3:1.

The term “edge” as used herein is a broad term and is to be given its ordinary and customary meaning to a person of ordinary skill in the art and is not to be limited to a special or customized meaning. The term specifically may refer, without limitation, to at least one element of the network configured for connecting the nodes. The edges may have a length, i.e. extension in longitudinal extension of the layer, and a thickness, i.e. extension vertical to the longitudinal extension of the layer. The edges may have different shapes such as tube like, prismatic, specifically cubic, cylindrical and the like.

The term “repeating unit” as used herein is a broad term and is to be given its ordinary and customary meaning to a person of ordinary skill in the art and is not to be limited to a special or customized meaning. The term specifically may refer, without limitation, to the fact that the network comprises a plurality of units, wherein at least two units of the network are identical. In particular, all units of the network are identical such that the network has a regular structure.

By changing the shape and the pattern of the nodes in the layers it may be possible to adapt and/or select properties of the composite element without changing the material in the single layers. This, especially, applies to the effective density, in particular as a result of adapting and/or selecting the packing of the single layers, and the mechanical properties, in particular as a result of changing a contact area between the single layers.

Each layer comprises a material with cellular structure. “Material with cellular structure” means a material having cells (synonymous pores) distributed within its structure. In a preferred embodiment of the composite element according to the present invention, each layer consists of the polymeric material with cellular structure. “Polymeric material with cellular structure” means a polymeric material having cells (synonymous pores) distributed within its structure. Preferably, the polymeric material with cellular structure is a foam made of the polymeric material.

The polymeric material with cellular structure of each layer of the composite element may be independently from each other the same or different. In one preferred embodiment, the polymeric material with cellular structure of each layer is the same. In another preferred embodiment, the polymeric material with cellular structure of at least one layer of the composite element is different to the polymeric material with cellular structure of the other layer(s). In another preferred embodiment, the polymeric material with cellular structure of at least one layer of the composite element is connected to a non-cellular material of different structure. For example, such a polymeric material may be used as layer for composition of floor covering. Hardness of each layer of the composite element may be independently from each other the same or different. Stiffness of each layer of the composite element may be independently from each other the same or different. Density of each layer of the composite element may be independently from each other the same or different. Rebound resilience of each layer of the composite element may be independently from each other the same or different.

The polymeric material with cellular structure is preferably a foam, more preferably a foam according to DIN 7726. In principle, no restrictions exist regarding modes of foam preparation. Preferably, the polymeric material with cellular structure of each layer is prepared by a process selected from the group consisting of reactive foaming, preferably injection moulding or casting, and extrusion foaming, wherein the process is carried out continuously or discontinuously. According to a preferred embodiment, a suitable mold is used for shaping the foam. In principle, no restrictions exist regarding the polymeric material, provided that it is capable of forming a cellular structure. A preferred embodiment of the present invention is related to a composite element, wherein the polymeric material with cellular structure of each layer is independently selected from polyurethanes, preferably from polyurethane foams.

For the purposes of the invention, “polyurethane” comprises all of the known polyisocyanate polyaddition products. These comprise adducts of isocyanate and alcohol, and they also comprise modified polyurethanes which can comprise isocyanurate structures, allophanate structures, urea structures, carbodiimide structures, uretonimine structures, and biuret structures, and which can comprise further isocyanate adducts. These polyurethanes of the invention comprise in particular foams based on polyisocyanate polyaddition products, e.g. elastomeric foams, flexible foams, semirigid foams and rigid foams. For the purposes of the invention, the term polyurethanes also include polymer blends comprising polyurethanes and further polymers, and also foams made of said polymer blends. Preferably, the polymeric material with cellular structure of each element is independently selected from the group of elastomeric foams, wherein the polymeric material is preferably selected from the group consisting of ethylenvinylacetate (EVA), poly butadiene, ethylene propylene diene (EPDM) rubber, styrene butadiene rubber (SBR), synthetic rubber, natural rubber, polyurea, and polyurethane.

The layer from a polymeric material may comprise, for example polyurethanes, in particular polyurethane foams prepared reacting a polyisocyanate composition, a polyol composition, and a blowing agent composition. The method may comprise preparing a layer from a polymeric material with cellular structure, preferably in a mold, wherein the layer consists of a network comprising nodes and edges, wherein the composite element has a height H vertical to each element's longitudinal extension, which is in the range of from 1 to 10000 mm and wherein the nodes are connected via the edges, and the layer has a volume, a longitudinal extension and a maximum height h vertical to the longitudinal extension. Preferably, the preparing of the layer comprises
(1) introducing into a mold at least the components
   (a) polyisocyanate composition;
   (b) polyol composition;
   (c) blowing agent composition;
(2) reacting components (a) and (b) by foaming,
   resulting in a layer from a polymeric material with cellular structure, wherein the layer consists of a network comprising nodes and edges, wherein the composite element has a height H vertical to each element's longitudinal extension, which is in the range of from 1 to 10000 mm and wherein the nodes are connected via the edges, and the layer has a volume, a longitudinal extension and a maximum height h vertical to the longitudinal extension.

Regarding the components (a), (b) and (c), suitable compositions are known to the person skilled in the art. Also here, preferably, at least one further component (d) selected from the group consisting of chain extenders (d1), crosslinkers (d2) and catalysts (d3) is added. Further, if appropriate, other auxiliaries and additives (e) are added to give a reaction mixture and permitting completion of the reaction. Regarding the components (d), i.e. (d1), (d2) and (d3) and (e), suitable compositions are known to the person skilled in the art.

The amounts reacted of the polyisocyanate composition (a), the polyol compositon (b) and the blowing agent compositon (c) are generally such that the equivalence ratio of NCO groups of the polyisocyanates in (a) to the total number of reactive hydrogen atoms in components (b) and (c), is from 0.75 to 1.5:1, preferably from 0.80 to 1.25:1. If the polymeric material with cellular structure comprises at least some isocyanurate groups, the ratio used of NCO groups of the polyisocyanates in (a) to the total number of reactive hydrogen atoms in component (b) and (c) and, if appropriate, (d) and (e) is usually from 1.5 to 20:1, preferably from 1.5 to 8:1. A ratio of 1:1 here corresponds to an isocyanate index of 100.

There is respectively very little quantitative and qualitative difference between the specific starting materials (a) to (e) used for producing polyurethanes when the polyurethane to be produced of the invention is an elastomeric foam, a flexible foam, a semirigid foam, a rigid foam, or an integral foam. By way of example, the starting materials for producing a flexible foam are described in WO 2006/034800 A1 and EP 1529792 A1, the starting materials for producing a semirigid foam are described in “Kunststoffhandbuch, Band 7, Polyurethane” [Plastics handbook, volume 7, Polyurethanes], Carl Hanser Verlag, 3rd edition, 1993, chapter 5.4, the starting materials for producing a rigid foam are described in WO 2006/042674 A1, and the starting materials for producing an integral foam are described in EP 0364854 A1, U.S. Pat. No. 5,506,275, or EP 0897402 A1.

The process according to the present invention may also comprise further steps. A first layer from a polymeric material with cellular structure may be obtained as outlined above. The first layer may be combined with one or more additional layers. The further layers may be from a polymeric material with cellular structure of also from a non-cellular material. Further layers may comprise nodes and edges or may also be planar in the context of the present invention.

The layers may be superimposed in a way that the individual layers are at least partially stacked. The superimposed layers further may be at least partially bonded for example in a defined contact area.

According to a further aspect, the present invention, the process further comprises the following steps (II) and (III):
(II) superimposing the first layer with at least one further layer so that the layers are at least partially stacked;
(III) bonding the layers.

According to a further aspect, the present invention is also directed to the method for preparing a composite element as disclosed above, wherein the further consists of a non-cellular material.

According to a further aspect, the present invention is also directed to the method for preparing a composite element as disclosed above, wherein the further layer consists of a network having repeating units which comprise nodes and edges, has a volume, a longitudinal extension and a maximum height h vertical to the longitudinal extension and comprises a polymeric material with cellular structure.

Suitable additional layers may for example also be adhesive layers. According to a further aspect, the present invention is also directed to the method for pre-paring a composite element as disclosed above, wherein an adhesive layer is placed between one or more of the layers.

Bonding according to step (III) may be achieved by any suitable method known to the person skilled in the art. In principle, no restrictions exist regarding the adhesion between the individual elements as long as the elements stick together. Thus, adhesion between the individual elements may simply be based on mechanical or electrostatic adhesion. Preferably, the elements of the composite element are adhesively bonded in the contact area, preferably by a method selected from the group consisting of stitching, steam-chest molding, gluing and others.

According to a further aspect, the present invention is also directed to the method for preparing a composite element as disclosed above, wherein thermal bonding and/or an adhesive are used in step (III).

For the purposes of this invention, elastomeric polyurethane foams are polyurethane foams according to DIN 7726, where these exhibit no residual deformation beyond 2% of their initial thickness 10 minutes after brief deformation amounting to 50% of their thickness to DIN 53 577.

The compressive stress value for flexible polyurethane foams of the invention at 10% compression, or the compressive strength of these foams according to DIN 53 421/DIN EN ISO 604, is 15 kPa or less, preferably from 1 to 14 kPa, and in particular from 4 to 14 kPa. The compressive stress value for semi rigid polyurethane foams of the invention at 10% compression to DIN 53 421/DIN EN ISO 604 is from greater than 15 to less than 80 kPa. The open-cell factor to DIN ISO 4590 of semi rigid polyurethane foams of the invention and of flexible polyurethane foams of the invention is preferably greater than 85%, particularly preferably greater than 90%. Further details concerning flexible polyurethane foams of the invention and semi rigid polyurethane foams of the invention are found in “Kunststoffhandbuch, Band 7, Polyurethane” [Plastics hand-book, volume 7, Polyurethanes], Carl Hanser Verlag, 3rd edition, 1993, chapter 5.

The compressive stress value for rigid polyurethane foams of the invention at 10% compression is greater than or equal to 80 kPa, preferably greater than or equal to 120 kPa, particularly preferably greater than or equal to 150 kPa. The closed-cell factor to DIN ISO 4590 for the rigid polyurethane foam is moreover greater than 80%, preferably greater than 90%. Further details concerning rigid polyurethane foams of the invention are found in “Kunststoffhandbuch, Band 7, Polyurethane” [Plastics handbook, volume 7, Polyurethanes], Carl Hanser Verlag, 3rd edition, 1993, chapter 6.

Integral polyurethane foams are polyurethane foams according to DIN 7726 having a marginal zone in which the density is higher than in the core, as a result of the shaping process. The overall density here averaged over the core and the marginal zone is preferably above 100 g/L. For the purposes of the invention, integral polyurethane foams can again be rigid polyurethane foams, semirigid polyurethane foams, flexible polyurethane foams or elastomeric polyurethane foams. Further details concerning the integral polyurethane foams of the invention are found in “Kunststoffhandbuch, Band 7, Polyurethane” [Plastics handbook, volume 7, Polyurethanes], Carl Hanser Verlag, 3rd edition, 1993, chapter 7.

The optimal design of the composite element may depend on a plurality of factors and may differ from application to application. The term “design” as used herein is a broad term and is to be given its ordinary and customary meaning to a person of ordinary skill in the art and is not to be limited to a special or customized meaning. The term specifically may refer, without limitation, to configuration of the composite element such as configuration of the individual layers, in particular shape of single nodes, position of nodes within the single layer; position of edges within the layer and/or with respect to nodes, thickness of nodes, length of edges and thickness of edges. The term “designing” as used herein is a broad term and is to be given its ordinary and customary meaning to a person of ordinary skill in the art and is not to be limited to a special or customized meaning. The term specifically may refer, without limitation, to a procedure of planning and/or specifying the composite element.

The present invention proposes a method for predicting the at least one mechanical property of the composite element. The term “predicting the at least one mechanical property” as used herein is a broad term and is to be given its ordinary and customary meaning to a person of ordinary skill in the art and is not to be limited to a special or customized meaning. The term specifically may refer, without limitation, to a process of determining an expected mechanical property of a theoretical or real composite element, in particular based on at least one simulation. The mechanical property comprises one or more of tension property, pressure property, shear property, temperature property and a combination thereof. Specifically, the mechanical property may be at least one property selected from the group consisting of: solid volume fraction; relative stiffness; damping properties; characteristics of stress vs. strain curve; hardness; energy dissipation; tensile properties; properties under compression; properties under shear; properties under complex deformations; anisotropy; thermal extension. The term “solid volume fraction” as used herein is a broad term and is to be given its ordinary and customary meaning to a person of ordinary skill in the art and is not to be limited to a special or customized meaning. The term specifically may refer, without limitation, to fraction of volume of the material with cellular structure within the layers divided by the volume of the whole composite element. The term “relative stiffness” as used herein is a broad term and is to be given its ordinary and customary meaning to a person of ordinary skill in the art and is not to be limited to a special or customized meaning. The term specifically may refer, without limitation, to stiffness of the composite element in comparison to the cellular material itself, in particular to the non-structured cellular material itself. The term “damping properties” as used herein is a broad term and is to be given its ordinary and customary meaning to a person of ordinary skill in the art and is not to be limited to a special or customized meaning. The term specifically may refer, without limitation, to the energy dissipation during a cyclic deformation.

The method comprises the following method steps which, specifically, may be performed in the given order. Still, a different order is also possible. It is further possible to perform two or more of the method steps fully or partially simultaneously. Further, one or more or even all of the method steps may be performed once or may be performed repeatedly, such as repeated once or several times. Further, the method may comprise additional method steps which are not listed.

The method comprises the following steps:
a) providing at least one input parameter set, wherein the input parameter set comprises a plurality of parameters defining properties of each of the single layers;
b) determining at least one geometric model of the composite element based on the input parameter set using at least one design tool;
c) determining at least one mechanical property of the geometric model of the composite element by using at least one numerical simulation, wherein the mechanical property comprises one or more of tension property, pressure property, shear property, temperature property and a combination thereof.

The term “input parameter set” as used herein is a broad term and is to be given its ordinary and customary meaning to a person of ordinary skill in the art and is not to be limited to a special or customized meaning. The term specifically may refer, without limitation, to a plurality of arbitrary parameters on which the prediction is based and/or for which the prediction is performed. As will be outlined in detail below, the geometric model may be defined by a plurality of parameters. At least some of the parameters may be set in accordance with the parameters of the input parameter set. The input parameter set may comprise at least one parameter selected from the group consisting of: shape of single nodes; position of nodes within the single layer; position of edges within the layer and/or with respect to nodes; thickness of nodes; length of edges; thickness of edges, contact area between single layers. The input parameter set may comprise at least one parameter defining a stacking of the layers of the composite element.

The term “providing the input parameter set” as used herein is a broad term and is to be given its ordinary and customary meaning to a person of ordinary skill in the art and is not to be limited to a special or customized meaning. The term specifically may refer, without limitation, to inputting and/or selecting the input parameter set via at least one communication interface. The term “communication interface” as used herein is a broad term and is to be given its ordinary and customary meaning to a person of ordinary skill in the art and is not to be limited to a special or customized meaning. The term specifically may refer, without limitation, to an item or element forming a boundary configured for transferring information. In particular, the communication interface may be configured for transferring information from a computational device, e.g. a computer, such as to send or output information, e.g. onto another device. Additionally or alternatively, the communication interface may be configured for transferring information onto a computational device, e.g. onto a computer, such as to receive information. The communication interface may specifically provide means for transferring or exchanging information. In particular, the communication interface may provide a data transfer connection, e.g. Bluetooth, NFC, inductive coupling or the like. As an example, the communication interface may be or may comprise at least one port comprising one or more of a network or internet port, a USB-port and a disk drive. The communication interface may be at least one web interface.

The term “geometric model of the composite element” as used herein is a broad term and is to be given its ordinary and customary meaning to a person of ordinary skill in the art and is not to be limited to a special or customized meaning. The term specifically may refer, without limitation, to information on a mathematical, in particular three-dimensional, representation of the composite element or at least one part of the composite element such as a volume element of the composite element. Specifically, the geometric model of the composite element may be present in a computer-readable form, such as in a computer compatible data set, specifically a digital data set. As an example, the geometric model of the composite element may be or may comprise computer-aided-design-data (CAD data). Specifically, geometric model of the composite element may be or may comprise CAD data describing the form or shape of the composite element and/or the structure of the single layers.

The term “design tool” as used herein is a broad term and is to be given its ordinary and customary meaning to a person of ordinary skill in the art and is not to be limited to a special or customized meaning. The term specifically may refer, without limitation, to a tool, in particular software, configured for generating the geometric model of the composite element. The design tool may be configured for modeling each of the single layers and a combination of the single layers forming the composite element. The design tool may comprise a computer-aided design (CAD) tool. For example, the software GeoDict® may be used as design tool.

The design tool may be configured for geometric modeling, specifically for generating at least one 3D model for the geometric properties of the composite element. The geometric properties may comprise information about packing density within the single layers and/or layer distance. Step b) may comprise at least one geometric analysis, wherein the geometric analysis comprises determining packing density and/or layer distance. The design tool may be configured for prescribing behavior of the geometric model under static, quasi static, dynamic or and cyclic load including tension, compression, shear, temperature and (multiaxial) combinations thereof.

The design tool may comprise one or more of machine learning, deep learning, neural networks, or other form of artificial intelligence. The geometric model of the composite element may be generated by using machine-learning, in particular using at least one artificial neural network. The term “machine-learning” as used herein is a broad term and is to be given its ordinary and customary meaning to a person of ordinary skill in the art and is not to be limited to a special or customized meaning. The term specifically may refer, without limitation, to a method of using artificial intelligence (AI) for automatically model building, in particular of prediction models.

Training of the design tool may be performed using at least one machine-learning system. The term “machine-learning system” as used herein is a broad term and is to be given its ordinary and customary meaning to a person of ordinary skill in the art and is not to be limited to a special or customized meaning. The term specifically may refer, without limitation, to a system or unit comprising at least one processing unit such as a processor, microprocessor, or computer system configured for machine learning, in particular for executing a logic in a given algorithm. The machine-learning system may be configured for performing and/or executing at least one machine-learning algorithm, wherein the machine-learning algorithm is configured for building the at least one machine-learning model. The machine-learning model may comprise at least one machine-learning architecture and model parameters. For example, the machine-learning architecture may be or may comprise one or more of: linear regression, logistic regression, random forest, naive Bayes classifications, nearest neighbors, neural networks, convolutional neural networks, generative adversarial networks, support vector machines, or gradient boosting algorithms or the like.

The term “training”, also denoted learning, as used herein, is a broad term and is to be given its ordinary and customary meaning to a person of ordinary skill in the art and is not to be limited to a special or customized meaning. The term specifically may refer, without limitation, to a process of building the machine-learning model, in particular determining and/or updating parameters of the machine-learning model. The machine-learning model may be at least partially data-driven. For example, the machine-learning model may be based on experimental data, such as data determined by manufacturing a plurality of composite elements having pre-defined parameters.

The determining of the mechanical property of the geometric model of the composite element is performed by using at least one numerical simulation. Specifically, the numerical simulation is a Finite-Element-Method (FEM) simulation. The FEM may be configured for solving partial differential equations in two or three space variables considering boundary conditions. For example, the FEM simulation may be a voxel based FEM simulation. For example, the software GeoDict® may be used as FEM simulation. The FEM simulation may comprise one or more of machine learning, deep learning, neural networks, or other form of artificial intelligence. For example, may comprise at least one neural network trained on experimental data, such as data determined by measuring mechanical properties of a plurality of composite elements.

The determining of the mechanical property may be performed using a modeling approach. The modelling approach may comprise using at least one physical model based on knowledge of physical effects. In addition, to the numerical solutions such as the FEM simulation as described above, the physical effects may be modeled by using analytical solutions. The modeling approach may further comprise using at least one statistical model, in particular based on experimental data. The statistical model may be based on machine learning, deep learning and the like.

Determining of the geometrical model composite element using the design tool and determining the mechanical property of the geometrical model composite element using the numerical simulation may allow reliable and robust prediction of the mechanical property. Specifically, the method allows for reliable and robust predicting the mechanical property. This may allow avoiding trial and error loops with real samples and measurements in the development stage.

The present invention may allow for optimization of desired parameters and definition of limits and possibilities via simulation instead for trials. Specifically, the present invention may allow for reliable prediction of damping and the design of damping elements with application in acoustics, protective gear, cushioning and/or comfort for footwear.

The method may comprise providing the determined mechanical property. The providing may comprise one or more of displaying, storing, providing to an interface, and transmitting to another device. The term “providing the determined mechanical property” as used herein is a broad term and is to be given its ordinary and customary meaning to a person of ordinary skill in the art and is not to be limited to a special or customized meaning. The term specifically may refer, without limitation, to presenting and/or displaying and/or communicating the determined mechanical property, e.g. to a user. The providing may be performed using at least one output unit. The term “output unit” as used herein is a broad term and is to be given its ordinary and customary meaning to a person of ordinary skill in the art and is not to be limited to a special or customized meaning. The term specifically may refer, without limitation, to at least one interface configured for providing the determined mechanical property, e.g. to at least one user. The output unit may comprise at least one display device.

The method may be a self-learning method. The term “self-learning method”, as used herein, is a broad term and is to be given its ordinary and customary meaning to a person of ordinary skill in the art and is not to be limited to a special or customized meaning. The term specifically may refer, without limitation, to ability to learn with every repetition of the method and, in particular, to improve over time in the sense of providing an as far as possible reliable mechanical property. The method may comprise using at least one artificial intelligence (AI-) system. The method may comprise using at least one machine-learning tool, in particular a deep learning architecture. The method may be performed completely automatic. The complete automatization of the method may allow the Al-system to find optimal parameters and models on its own. Specifically, the method may be self-optimizing by setting its parameters iteratively to fulfill a pre-defined final goal without human interaction. To this end, a machine learning model is used. Based on observations the machine learning model facilitates the prediction of the mechanical property.

In a further aspect of the invention, a computer program for predicting at least one mechanical property of at least one composite element, configured for causing a computer or a computer network to fully or partially perform the method according to the present invention, when executed on the computer or the computer network. The computer program is configured to perform at least one of steps a) to c) of the method for predicting at least one mechanical property according to the present invention.

Specifically, the computer program may be stored on a computer-readable data carrier and/or on a computer-readable storage medium. As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Further disclosed and proposed herein is a computer program product having program code means, in order to perform the method for predicting at least one mechanical property according to the present invention in one or more of the embodiments enclosed herein when the program is executed on a computer or computer network. Specifically, the program code means may be stored on a computer-readable data carrier and/or computer-readable storage medium.

Further disclosed and proposed herein is a data carrier having a data structure stored thereon, which, after loading into a computer or computer network, such as into a working memory or main memory of the computer or computer network, may execute the method for predicting at least one mechanical property according to the present invention in one or more of the embodiments disclosed herein.

Further disclosed and proposed herein is a computer program product with program code means stored on a machine-readable carrier, in order to perform the method for predicting at least one mechanical property according to the present invention one or more of the embodiments disclosed herein, when the program is executed on a computer or computer network. As used herein, a computer program product refers to the program as a tradable product. The product may generally exist in an arbitrary format, such as in a paper format, or on a computer-readable data carrier. Specifically, the computer program product may be distributed over a data network.

In a further aspect, a computer implemented method for determining a layout of at least one composite element comprising at least two layers is disclosed. Each layer comprises a network having repeating units which comprise nodes and edges. Each layer has a volume, a longitudinal extension and a maximum height h vertical to the longitudinal extension and comprises a material with cellular structure. The layers are stacked.

The method comprises the following method steps which, specifically, may be performed in the given order. Still, a different order is also possible. It is further possible to perform two or more of the method steps fully or partially simultaneously. Further, one or more or even all of the method steps may be performed once or may be performed repeatedly, such as repeated once or several times. Further, the method may comprise additional method steps which are not listed. The method comprises the following steps:
i) retrieving at least one target criterion for a target composite element;
ii) predicting at least one mechanical property of a start composite element using a method according to the present invention for predicting at least one mechanical property, wherein properties of each of the single layers of the start composite element are defined by the input parameter set;
iii) at least one optimization step, wherein the optimization step comprises determining a target parameter set for the target composite element by comparing the determined mechanical property with the target criterion, wherein the target parameter is set by adapting the input parameter set depending on the comparison in case the target criterion is not fulfilled, or by setting the input parameter set as target parameter set in case the target criterion is fulfilled;
iv) providing the determined target parameter set as layout for the composite element.

For possible definitions of most of the terms used herein, reference may be made to the description of the computer implemented method for predicting at least one mechanical property above or as described in further detail below.

The term “layout” as used herein is a broad term and is to be given its ordinary and customary meaning to a person of ordinary skill in the art and is not to be limited to a special or customized meaning. The term specifically may refer, without limitation, to configuration and/or properties of the elements of the composite element such as shape of single nodes, position of nodes within the single layer, position of edges within the layer and/or with respect to nodes, thickness of nodes, length of edges, thickness of edges, contact area between single layers.

The term “retrieving the target criterion” as used herein is a broad term and is to be given its ordinary and customary meaning to a person of ordinary skill in the art and is not to be limited to a special or customized meaning. The term specifically may refer, without limitation, to the process of a system, specifically a computer system, generating the target criterion and/or obtaining the target criterion from an arbitrary data source, such as from a data storage, from a network or from a further computer or computer system. The retrieving specifically may take place via at least one computer interface, such as via a port such as a serial or parallel port. The retrieving may comprise several sub-steps, such as the sub-step of obtaining one or more items of primary information and generating secondary information by making use of the primary information, such as by applying one or more algorithms to the primary information, e.g. by using a processor.

The term “optimization”, as used herein, is a broad term and is to be given its ordinary and customary meaning to a person of ordinary skill in the art and is not to be limited to a special or customized meaning. The term specifically may refer, without limitation, to the process of selecting of a best parameter set, denoted target parameter set, with regard to the target criterion from a parameter space of possible parameters.

The term “target criterion” as used herein is a broad term and is to be given its ordinary and customary meaning to a person of ordinary skill in the art and is not to be limited to a special or customized meaning. The term specifically may refer, without limitation, to a desired and/or required physical, in particular mechanical, property of the composite element. The target criterion may refer to at least one criterion under which the optimization is performed. The target criterion may comprise at least one optimization goal and accuracy and/or precision. The target criterion may be pre-specified such as by at least one customer request. The target criterion may be at least one user's specification. The user may select the optimization goal and/or a desired accuracy and/or precision. The target criterion may comprise at least one value of a physical property selected from the group consisting of: solid volume fraction; relative stiffness; damping properties; characteristics of stress vs. strain curve; hardness; energy dissipation; tensile properties; properties under compression; properties under shear; properties under complex deformations; anisotropy; thermal extension. The term “target composite element” as used herein is a broad term and is to be given its ordinary and customary meaning to a person of ordinary skill in the art and is not to be limited to a special or customized meaning. The term specifically may refer, without limitation, to a composite element having the desired and/or required properties at least within tolerances.

The optimization step may comprises determining the target parameter set by applying an optimizing algorithm in terms of the target criterion on a trained machine-learning model. The machine-learning model may comprise one or more of: linear regression, logistic regression, random forest, naive Bayes classifications, nearest neighbors, neural networks, convolutional neural networks, generative adversarial networks, support vector machines, or gradient boosting algorithms or the like.

The method comprises providing the determined target parameter set as layout for the composite element. The providing may comprise one or more of displaying, storing, providing to an interface, and transmitting to another device. The providing may be performed using at least one output unit. The output unit may comprise at least one display device.

The method may comprise repeating steps i) to iv), wherein the determined target parameter set is used as input parameter set. The method may be a self-learning method. The method may comprise using at least one artificial intelligence (AI-) system. The method may comprise using at least one machine-learning tool, in particular a deep learning architecture. The method may be performed completely automatic. The complete automatization of the method may allow the AI-system to find the optimal layout on its own. Specifically, the method may be self-optimizing by setting its parameters iteratively to fulfill a pre-defined final goal without human interaction. To this end, a machine learning model is used. Based on observations the machine learning model facilitates the finding of a best or optimal layout.

The method further may comprise prototyping the target composite element having the layout determined in step iv). The term “prototyping” as used herein is a broad term and is to be given its ordinary and customary meaning to a person of ordinary skill in the art and is not to be limited to a special or customized meaning. The term specifically may refer, without limitation, to the process of manufacturing a full-scale and functional model or form of an arbitrary element or object. In particular, the prototype may be a first model of an element or object and may be used for testing and/or verification of at least one characteristic or specification of the element or object. Specifically, the prototype may be manufactured prior to a large-scale production process or a mass production process. A prototype may, for example, be produced or manufactured as a part of a development phase of the element or object, such as of the composite element. Thus, the prototyping of the composite element may specifically be performed before starting a large scale production process or manufacturing of the composite element.

In a further aspect of the invention, a computer program for determining a layout of at least one composite element, configured for causing a computer or a computer network to fully or partially perform the method for determining a layout according to the present invention, when executed on the computer or the computer network. The computer program is configured to perform at least steps i) to iv) of the method for determining a layout.

Further disclosed and proposed herein is a computer-readable storage medium comprising instructions which, when executed by a computer or computer network, cause to carry out at least steps i) to iv) of the method for determining a layout according to the present invention.

Further disclosed and proposed herein is a computer program product having program code means, in order to perform the method for determining a layout according to the present invention in one or more of the embodiments enclosed herein when the program is executed on a computer or computer network. Specifically, the program code means may be stored on a computer-readable data carrier and/or computer-readable storage medium.

Further disclosed and proposed herein is a data carrier having a data structure stored thereon, which, after loading into a computer or computer network, such as into a working memory or main memory of the computer or computer network, may execute the method for determining a layout according to the present invention in one or more of the embodiments disclosed herein.

Further disclosed and proposed herein is a computer program product with program code means stored on a machine-readable carrier, in order to perform the method for determining a layout according to the present invention one or more of the embodiments disclosed herein, when the program is executed on a computer or computer network. As used herein, a computer program product refers to the program as a tradable product. The product may generally exist in an arbitrary format, such as in a paper format, or on a computer-readable data carrier. Specifically, the computer program product may be distributed over a data network.

In a further aspect of the invention, an automated control system for predicting at least one mechanical property of at least one composite element comprising at least two layers is proposed. Each layer comprises a network having repeating units which comprise nodes and edges. Each layer has a volume, a longitudinal extension and a maximum height h vertical to the longitudinal extension and comprises a material with cellular structure. The layers are stacked. The control system comprises
at least one communication interface configured for receiving at least one input parameter set comprising a plurality of parameters defining properties of each of the single layers;
at least one design tool configured for determining at least one geometric model of the composite element based on the input parameter set;
at least one numerical simulation configured for determining a mechanical property of the geometric model of the composite element, wherein the mechanical property comprises one or more of tension property, pressure property, shear property, temperature property and a combination thereof.

The control system may be configured for performing the method for predicting at least one mechanical property of at least one composite element. For possible definitions of most of the terms used herein, reference may be made to the description of the computer implemented methods above or as described in further detail below.

As used herein, the term “control system” may refer to at least one system configured for controlling the at least one mechanical property of at least one composite element. The control system may be configured for setting at least one process parameter for manufacturing the composite element having the determined mechanical properties and/or depending on the determined mechanical properties.

In a further aspect of the invention, an automated layout designing system for determining a layout of at least one composite element comprising at least two layers is proposed. Each layer comprises a network having repeating units which comprise nodes and edges. Each layer has a volume, a longitudinal extension and a maximum height h vertical to the longitudinal extension and comprises a material with cellular structure. The layers are stacked. The layout designing system comprises
at least one communication interface configured for retrieving at least one target criterion for a target composite element and for receiving at least one input parameter set comprising a plurality of parameters defining properties of each of the single layers;
at least one material modelling tool configured for determining at least one geometric model of the composite element from the input parameter set;
at least one numerical simulation configured for determining at least one mechanical property of the geometric model of the composite element, wherein the mechanical property comprises one or more of tension property, pressure property, shear property, temperature property and a combination thereof;
at least one processing unit configured for performing at least one optimization step, wherein the optimization step comprises determining a target parameter set for the target composite element by comparing the determined mechanical property with the target criterion, wherein the target parameter is set by adapting the input parameter set depending on the comparison in case the target criterion is not fulfilled, or by setting the input parameter set as target parameter set in case the target criterion is fulfilled;
at least one output unit configured for providing the determined target parameter set as layout for the composite element.

The layout designing system may be configured for performing the method for determining a layout according to the present invention. For possible definitions of most of the terms used herein, reference may be made to the description of the computer implemented methods above or as described in further detail below.

In a further aspect of the invention, a use of a control system according to the present invention is disclosed for controlling mechanical properties of a composite element selected from the group consisting of: a damping element, preferably as damper for seismic vibration control of constructions, preferably buildings or bridges; a sound damping element; mattress or part of a mattress, furniture or flooring element, element of automotive industry, preferably dashboard, bearing, tire, shoe, preferably a shoe sole, more preferably a part of a shoe sole; a body protector such as for sports equipment, preferably for knee protection, elbow protection, shoulder protection, protective helmet.

In a further aspect of the invention, a use of a layout designing system according to the present invention is proposed for designing a layout of a composite element selected from the group consisting of: a damping element, preferably as damper for seismic vibration control of constructions, preferably buildings or bridges; a sound damping element; mattress or part of a mattress, furniture or flooring element, element of automotive industry, preferably dashboard, bearing, tire, shoe, preferably a shoe sole, more preferably a part of a shoe sole; a body protector such as for sports equipment, preferably for knee protection, elbow protection, shoulder protection, protective helmet. Moreover, the designing of the layout may comprise designing of further design elements such as for decor, ornaments and the like. The present invention allows for strongly dampening performance. Applications are possible in which strongly damping materials in this construction represent an even more damping system.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not be repeated, non-withstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person recognizes, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

Summarizing and without excluding further possible embodiments, the following embodiments may be envisaged:

Embodiment 1: Computer implemented method for predicting at least one mechanical property of at least one composite element comprising at least two layers, wherein each layer comprises a network having repeating units which comprise nodes and edges, wherein each layer has a volume, a longitudinal extension and a maximum height h vertical to the longitudinal extension and comprises a material with cellular structure, wherein the layers are stacked, wherein the method comprises the following steps:
a) providing at least one input parameter set, wherein the input parameter set comprises a plurality of parameters defining properties of each of the single layers;
b) determining at least one geometric model of the composite element based on the input parameter set using at least one design tool;
c) determining at least one mechanical property of the geometric model of the composite element by using at least one numerical simulation, wherein the mechanical property comprises one or more of tension property, pressure property, shear property, temperature property and a combination thereof.

Embodiment 2: The method according to the preceding embodiment, wherein the mechanical property is at least one property selected from the group consisting of: solid volume fraction; relative stiffness; damping properties; characteristics of stress vs. strain curve; hardness; energy dissipation; tensile properties; properties under compression; properties under shear; properties under complex deformations; anisotropy; thermal extension.

Embodiment 3: The method according to any one of the preceding embodiments, wherein step b) comprises at least one geometric analysis, wherein the geometric analysis comprises determining packing density and/or layer distance.

Embodiment 4: The method according to any one of the preceding embodiments, wherein the input parameter set comprises at least one parameter selected from the group consisting of: shape of single nodes; position of nodes within the single layer; position of edges within the layer and/or with respect to nodes; thickness of nodes; length of edges; thickness of edges; contact area between single layers.

Embodiment 5: The method according to the preceding embodiment, wherein the input parameter set comprises at least one parameter defining a stacking of the layers of the composite element.

Embodiment 6: The method according to any one of the preceding embodiments, wherein the design tool comprises a computer-aided design (CAD) tool.

Embodiment 7: The method according to any one of the preceding embodiments, wherein the numerical simulation is a Finite-Element-Method (FEM) simulation, wherein the FEM simulation is a voxel based FEM simulation.

Embodiment 8: The method according to any one of the preceding embodiments, wherein the method comprises providing the determined mechanical property, wherein the providing comprises one or more of displaying, storing, providing to an interface, and transmitting to another device.

Embodiment 9: Computer program for predicting at least one mechanical property of at least one composite element, configured for causing a computer or a computer network to fully or partially perform the method according to any one of the preceding embodiments, when executed on the computer or the computer network, wherein the computer program is configured to perform at least one of steps a) to c) of the method according to any one of the preceding embodiments.

Embodiment 10: A computer-readable storage medium comprising instructions which, when executed by a computer or computer network, cause to carry out at least one of steps a) to c) of the method according to any one of the preceding embodiments referring to a method.

Embodiment 11: Computer implemented method for determining a layout of at least one composite element comprising at least two layers, wherein each layer comprises a network having repeating units which comprise nodes and edges, wherein each layer has a volume, a longitudinal extension and a maximum height h vertical to the longitudinal extension and comprises a material with cellular structure, wherein the layers are stacked, wherein the method comprises the following steps:
i) retrieving at least one target criterion for a target composite element;
ii) predicting at least one mechanical property of a start composite element using a method according to any one of the preceding embodiments referring to a method, wherein properties of each of the single layers of the start composite element are defined by the input parameter set;
iii) at least one optimization step, wherein the optimization step comprises determining a target parameter set for the target composite element by comparing the determined mechanical property with the target criterion, wherein the target parameter is set by adapting the input parameter set depending on the comparison in case the target criterion is not fulfilled, or by setting the input parameter set as target parameter set in case the target criterion is fulfilled;
iv) providing the determined target parameter set as layout for the composite element.

Embodiment 12: The method according to any one of the preceding embodiments, wherein the method comprises repeating steps i) to iv), wherein the determined target parameter set is used as input parameter set.

Embodiment 13: The method according to any one of the preceding embodiments referring to a method for determining a layout, wherein the target criterion comprises at least one value of a physical property selected from the group consisting of: solid volume fraction; relative stiffness; damping curve; characteristics of stress vs. strain curve; hardness; energy dissipation; tensile properties; properties under compression; properties under shear; properties under complex deformations; anisotropy; thermal extension.

Embodiment 14: The method according to any one of the preceding embodiments referring to a method for determining a layout, wherein the optimization step comprises determining the target parameter set by applying an optimizing algorithm in terms of the target criterion on a trained machine-learning model.

Embodiment 15: The method according to the preceding embodiment, wherein the machine-learning model comprises one or more of: linear regression, logistic regression, random forest, naive Bayes classifications, nearest neighbors, neural networks, convolutional neural networks, generative adversarial networks, support vector machines, or gradient boosting algorithms or the like.

Embodiment 16: The method according to any one of the preceding embodiments referring to a method for determining a layout, wherein the providing comprises one or more of displaying, storing, providing to an interface, and transmitting to another device.

Embodiment 17: The method according to any one of the preceding embodiments referring to a method for determining a layout, wherein the method further comprises prototyping the target composite element having the layout determined in step iv).

Embodiment 18: Computer program for determining a layout of at least one composite element, configured for causing a computer or a computer network to fully or partially perform the method according to any one of the preceding embodiments referring to a method for determining a layout, when executed on the computer or the computer network, wherein the computer program is configured to perform at least steps i) to iv) of the method according to any one of the preceding embodiments referring to a method for determining a layout.

Embodiment 19: A computer-readable storage medium comprising instructions which, when executed by a computer or computer network, cause to carry out at least steps i) to iv) of the method according to any one of the preceding embodiments referring to a method for determining a layout.

Embodiment 20: Automated control system for predicting at least one mechanical property of at least one composite element comprising at least two layers, wherein each layer comprises a network having repeating units which comprise nodes and edges, wherein each layer has a volume, a longitudinal extension and a maximum height h vertical to the longitudinal extension and comprises a material with cellular structure, wherein the layers are stacked, wherein the control system comprises
at least one communication interface configured for receiving at least one input parameter set comprising a plurality of parameters defining properties of each of the single layers;
at least one design tool configured for determining at least one geometric model of the composite element based on the input parameter set;
at least one numerical simulation configured for determining a mechanical property of the geometric model of the composite element, wherein the mechanical property comprises one or more of tension property, pressure property, shear property, temperature property and a combination thereof.

Embodiment 21: The control system according to the preceding embodiment, wherein the control system is configured for performing the method according to any one of the preceding embodiments referring to a method for predicting at least one mechanical property of at least one composite element.

Embodiment 22: Automated layout designing system for determining a layout of at least one composite element comprising at least two layers, wherein each layer comprises a network having repeating units which comprise nodes and edges, wherein each layer has a volume, a longitudinal extension and a maximum height h vertical to the longitudinal extension and comprises a material with cellular structure, wherein the layers are stacked, wherein the layout designing system comprises
at least one communication interface configured for retrieving at least one target criterion for a target composite element and for receiving at least one input parameter set comprising a plurality of parameters defining properties of each of the single layers;
at least one material modelling tool configured for determining at least one geometric model of the composite element from the input parameter set;
at least one numerical simulation configured for determining at least one mechanical property of the geometric model of the composite element, wherein the mechanical property comprises one or more of tension property, pressure property, shear property, temperature property and a combination thereof;
at least one processing unit configured for performing at least one optimization step, wherein the optimization step comprises determining a target parameter set for the target composite element by comparing the determined mechanical property with the target criterion, wherein the target parameter is set by adapting the input parameter set depending on the comparison in case the target criterion is not fulfilled, or by setting the input parameter set as target parameter set in case the target criterion is fulfilled;
at least one output unit configured for providing the determined target parameter set as layout for the composite element.

Embodiment 23: The layout designing system according to the preceding embodiment, wherein the layout designing system is configured for performing the method according to any one of the preceding embodiments referring to a method for determining a layout.

Embodiment 24: Use of a control system according to any one of embodiments 20 or 21 for controlling mechanical properties of a composite element selected from the group consisting of: a damping element, preferably as damper for seismic vibration control of constructions, preferably buildings or bridges; a sound damping element; mattress or part of a mattress, furniture or flooring element, element of automotive industry, preferably dashboard, bearing, tire, shoe, preferably a shoe sole, more preferably a part of a shoe sole; a body protector such as for sports equipment, preferably for knee protection, elbow protection, shoulder protection, protective helmet.

Embodiment 25: Use of a system according to any one of embodiments 22 or 23 for designing a layout of a composite element selected from the group consisting of: a damping element, preferably as damper for seismic vibration control of constructions, preferably buildings or bridges; a sound damping element; mattress or part of a mattress, furniture or flooring element, element of automotive industry, preferably dashboard, bearing, tire, shoe, preferably a shoe sole, more preferably a part of a shoe sole; a body protector such as for sports equipment, preferably for knee protection, elbow protection, shoulder protection, protective helmet.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 shows a flowchart of an embodiment of a computer implemented method for predicting at least one mechanical property of at least one composite element according to the present invention;

FIG. 2 shows a flowchart of an embodiment of a computer implemented method for determining a layout of at least one composite element according to the present invention;

FIG. 3 shows an embodiment of an automated control system and automated layout designing system according to the present invention;

FIGS. 4A to 4T show embodiments of geometric model of the composite elements;

FIG. 5 shows a comparison of different layouts; and

FIG. 6 shows an embodiment of a composite element.

### DETAILED DESCRIPTION OF THE EMBODIMENTS

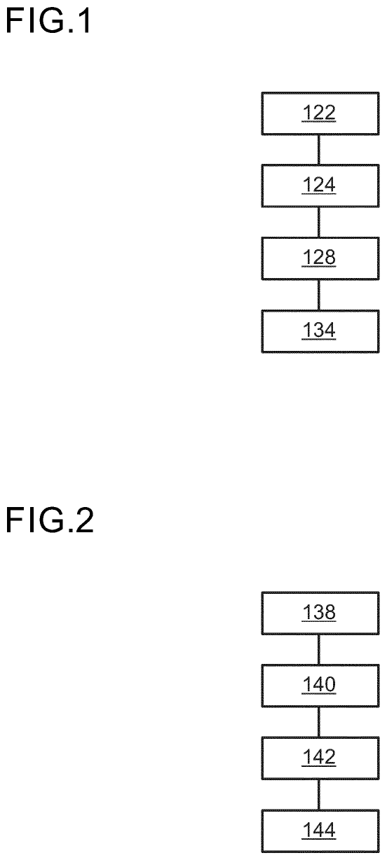

FIG. 1 shows a flowchart of an embodiment of a computer implemented method for predicting at least one mechanical property of at least one composite element 110 according to the present invention.

An embodiment of the composite element 110 is shown in a highly schematic fashion in FIG. 6. The composite element 110 may comprise two or more sub-elements. In principle, no restrictions exist regarding the number of sub-elements comprised by one composite element 110, provided that there are at least two elements present. Preferably, the composite element comprises at least three elements, more preferably from 3 to 10 elements.

In principle, no restrictions exist regarding the dimensions of the composite element 110, in particular, no restrictions exist regarding a height H of the composite element 110 vertical to each element's longitudinal extension. Preferably, the composite element 110 has a height H vertical to each element's longitudinal extension, which is in the range of from 1 to 10000 mm, more preferably in the range of from 5 to 1000 mm, more preferably in the range of from 5 to 100 mm.

The composite element 110 comprises at least two layers 112. Specifically, the layers 112 may be or may comprise mats. Each layer 112 has a volume, a longitudinal extension and a maximum height h vertical to the longitudinal extension. In principle, also no restrictions exist regarding the dimensions of each layer 112, provided that the dimensions of the composite element 110 are defined by the dimensions of the individual layers 112. For example, a sum of the individual dimensions of each layer 112 is equal to the dimensions of the composite element 110. However, in case of interlocked or engaged layers 112, the height of the composite element may be lower than the height of the individual layers. The layers 112 may have equal dimensions or different dimensions. For example, the composite element 110 may have a pyramidal layer structure with increasing longitudinal extensions of the layers 112 from up to down. Preferably, each layer's 112 height his in the range of from 0.25 to 2500 mm, more preferably in the range of from 0.5 to 250 mm, more preferably in the range of from 0.75 to 250 mm, more preferably in the range of from 1 to 25 mm.

The layers 112 are stacked. Specifically, in a direction vertical to the longitudinal extension the layers 112 may be arranged one above the other. The layers 112 may be at least in partial contact parallel to the longitudinal extension. In principle, no restrictions exist regarding the adhesion between the individual layers 112 as long as the layers are fixed together. Thus, adhesion between the individual layers 112 may simply be based on mechanical or electrostatic adhesion. Preferably, the layers 112 of the composite element 110 are adhesively bonded in a contact area, preferably by a method selected from the group consisting of stitching, steam-chest molding, gluing and others.

The layers 112 may have a closed surface (skin) at least in a contact area 113. Each layer 112 may have a skin at least in the contact area 113 with its adjacent element, however, each layer's 112 surface may be closed or open in non-contact areas, for example, in case of plate like layers, which are in contact over their larger surfaces, the sides, i.e. the smaller surfaces, where no contact with an adjacent element is given, may display open pores or may equally display a closed surface.

Each layer 112 comprises a network 114 having repeating units 120 which comprise nodes 116 and edges 118. The network 114 may be or may comprise a structured layer. Each whole individual layer 112 may be regarded as network 114 comprising nodes 116 and edges 118. Each layer 112 may comprise a plurality of nodes 116. The nodes 116 of each layer 112 may be arranged within the same plane. Each of the layers 112 may comprise holes or a thin membrane in a plane of the layer between the nodes 116, wherein the nodes 116 are connected via edges 118. The network 114 may be or comprise a pattern, in particular a regular pattern, in which the nodes 116 and edges 118 are arranged.

Each node 116 may have a shape such as a spherical shape, bipyramidal shape, cuboid shape, or a 3D polygonal shape. The nodes 116 of the at least two layers 112 and/or the nodes 116 of the individual layers 112 may be identical or different. Each node 116 may have a symmetric shape with respect to a plane of the layer 112. However, non-symmetric designs may be possible, too. For example, nodes 116 and edges 118 may be arranged in different planes of symmetry. Thus, parts of the individual nodes 116 below a plane of symmetry of the edges 118 may be smaller compared to parts of nodes 116 above the plane of symmetry of the edges 118, or vice versa. Embodiments, wherein parts of the individual nodes 116 below a plane of symmetry of the edges 118 are smaller compared to parts of nodes 116 above the plane of symmetry of the edges 118, may be advantageous for foaming processes at lower densities. In principle, no restrictions exist regarding the dimensions of the nodes 116 are given. For example, the nodes 116 may have an effective diameter of 0.002 m to 0.1 m. The nodes 116 may have a length, i.e. extension in longitudinal extension of the layer 112, and a thickness, i.e. extension vertical to the longitudinal extension of the layer 112. The structure of the network 114 may be defined by the position of the nodes 116 in the network. A relation of numbers of nodes and edges may be from 1:1 to 1:3. Height-proportions of edges and nodes may be from 1:2 to 1:10. Length-proportions of edges and nodes may be arbitrary, preferably from 1:10 to 5:1, more preferably from 1:10 to 3:1. The edges 118 may have a length, i.e. extension in longitudinal extension of the layer, and a thickness, i.e. extension vertical to the longitudinal extension of the layer 112.

By changing the shape and the pattern of the nodes 116 in the layers 112 it may be possible to adapt and/or select properties of the composite element 110 without changing the material in the single layers 112. This, especially, applies to the effective density, in particular as a result of adapting and/or selecting the packing of the single layers, and the mechanical properties, in particular as a result of changing a contact area 113 between the single layers.

Each layer 112 comprises a material with cellular structure. In a preferred embodiment of the composite element 110 according to the present invention, each layer consists of the polymeric material with cellular structure. Preferably, the polymeric material with cellular structure is a foam made of the polymeric material.

The polymeric material with cellular structure of each layer 112 of the composite element 110 may be independently from each other the same or different. In one preferred embodiment, the polymeric material with cellular structure of each layer 112 is the same. In another preferred embodiment, the polymeric material with cellular structure of at least one layer 112 of the composite element 110 is different to the polymeric material with cellular structure of the other layer(s) 112. In another preferred embodiment, the polymeric material with cellular structure of at least one layer 112 of the composite element 110 is connected to a non-cellular material of different structure. For example, such a polymeric material may be used as layer for composition of floor covering. Hardness of each layer 112 of the composite element 110 may be independently from each other the same or different. Stiffness of each layer 112 of the composite element 110 may be independently from each other the same or different. Density of each layer 112 of the composite element 110 may be independently from each other the same or different. Rebound resilience of each layer 112 of the composite element 110 may be independently from each other the same or different.

The optimal design of the composite element 110 may depend on a plurality of factors and may differ from application to application. The design may be or may comprise a configuration of the individual layers 112, in particular shape of single nodes 116, position of nodes 116 within the single layer 112; position of edges 118 within the layer 112 and/or with respect to nodes 116, thickness of nodes 116, length of edges 118 and thickness of edges 118.

The present invention proposes a method for predicting the at least one mechanical property of the composite element 110. The predicting of the at least one mechanical property comprises a process of determining an expected mechanical property of a theoretical or real composite element 110, in particular based on at least one simulation. The mechanical property comprises one or more of tension property, pressure property, shear property, temperature property and a combination thereof. Specifically, the mechanical property may be at least one property selected from the group consisting of: solid volume fraction; relative stiffness; damping properties; characteristics of stress vs. strain curve; hardness; energy dissipation; tensile properties; properties under compression; properties under shear; properties under complex deformations; anisotropy; thermal extension.

The method comprises the following method steps which, specifically, may be performed in the given order. Still, a different order is also possible. It is further possible to perform two or more of the method steps fully or partially simultaneously. Further, one or more or even all of the method steps may be performed once or may be performed repeatedly, such as repeated once or several times. Further, the method may comprise additional method steps which are not listed.

The method comprises the following steps:
a) (reference number 122) providing at least one input parameter set, wherein the input parameter set comprises a plurality of parameters defining properties of each of the single layers 112;
b) (reference number 124) determining at least one geometric model of the composite element based on the input parameter set using at least one design tool 126;
c) (reference number 128) determining at least one mechanical property of the geometric model of the composite element by using at least one numerical simulation 130, wherein the mechanical property comprises one or more of tension property, pressure property, shear property, temperature property and a combination thereof.

The input parameter set may comprise a plurality of arbitrary parameters on which the prediction is based and/or for which the prediction is performed. The geometric model may be defined by a plurality of parameters. At least some of the parameters may be set in accordance with the parameters of the input parameter set. The input parameter set may comprise at least one parameter selected from the group consisting of: shape of single nodes 116; position of nodes 116 within the single layer 112; position of edges 118 within the layer 112 and/or with respect to nodes 116; thickness of nodes 116; length of edges 118; thickness of edges 118, contact area 113 between single layers 112. The input parameter set may comprise at least one parameter defining a stacking of the layers 112 of the composite element 110.

The providing the input parameter set may comprise inputting and/or selecting the input parameter set via at least one communication interface 132. In particular, the communication interface 132 may be configured for transferring information from a computational device, e.g. a computer, such as to send or output information, e.g. onto another device. Additionally or alternatively, the communication interface 132 may be configured for transferring information onto a computational device, e.g. onto a computer, such as to receive information. The communication interface 132 may specifically provide means for transferring or exchanging information. In particular, the communication interface 132 may provide a data transfer connection, e.g. Bluetooth, NFC, inductive coupling or the like. As an example, the communication interface 132 may be or may comprise at least one port comprising one or more of a network or internet port, a USB-port and a disk drive. The communication interface 132 may be at least one web interface.

The geometric model of the composite element may be or may comprise information on a mathematical, in particular three-dimensional, representation of the composite element 110 or at least one part of the composite element 110 such of a volume element of the composite element 110. Specifically, the geometric model of the composite element may be present in a computer-readable form, such as in a computer compatible data set, specifically a digital data set. As an example, the geometric model of the composite element may be or may comprise computer-aided-design-data (CAD data). Specifically, geometric model of the composite element may be or may comprise CAD data describing the form or shape of the composite element 110 and/or the structure of the single layers 112.

The material modeling may be or may comprise a process of generating at least one 3D model for geometric properties of the composite element 110. The geometric properties may comprise information about packing density within the single layers 112 and/or layer distance. Step b) may comprise at least one geometric analysis, wherein the geometric analysis comprises determining packing density and/or layer distance. The design tool 126 may be or may comprise a tool, in particular software, configured for generating the geometric model of the composite element. The design tool 126 may be configured for modeling each of the single layers 112 and a combination of the single layers 112 forming the composite element 110. The design tool 126 may comprise a computer-aided design (CAD) tool. For example, the software GeoDict® may be used as design tool 126.

The design tool 126 may be configured for geometric modeling, specifically for generating at least one 3D model for the geometric properties of the composite element. The geometric properties may comprise information about packing density within the single layers and/or layer distance. Step b) may comprise at least one geometric analysis, wherein the geometric analysis comprises determining packing density and/or layer distance. The design tool 126 may be configured for prescribing behavior of the geometric model under static, quasi static, dynamic or and cyclic load including tension, compression, shear, temperature and (multiaxial) combinations thereof.

The design tool 126 may comprise one or more of machine learning, deep learning, neural networks, or other form of artificial intelligence. The geometric model of the composite element may be generated by using machine-learning, in particular using at least one artificial neural network. For example, the machine-learning may be based on one or more of: linear regression, logistic regression, random forest, naive Bayes classifications, nearest neighbors, neural networks, convolutional neural networks, generative adversarial networks, support vector machines, or gradient boosting algorithms or the like. The design tool 126 may be trained based on experimental data, such as data determined by manufacturing a plurality of composite elements 110 having pre-defined parameters.

The determining of the mechanical property of the geometric model of the composite element is performed by using at least one numerical simulation 130. Specifically, the numerical simulation 130 is at least one Finite-Element-Method (FEM) simulation. The FEM may be configured for solving partial differential equations in two or three space variables considering boundary conditions. For example, the FEM simulation may be a voxel based FEM simulation. For example, the software GeoDict® may be used as FEM simulation. The FEM simulation may comprise one or more of machine learning, deep learning, neural networks, or other form of artificial intelligence. For example, may comprise at least one neural network trained on experimental data, such as data determined by measuring mechanical properties of a plurality of composite elements 110.

Determining of the geometrical model composite element using the design tool 126 and determining the mechanical property of the geometrical model composite element using the numerical simulation 130 may allow reliable and robust prediction of the mechanical property. Specifically, the method allows for reliable and robust predicting the mechanical property. This may allow avoiding trial and error loops in the development stage.

The method may comprise providing the determined mechanical property, denoted with reference number 134. The providing may comprise one or more of displaying, storing, providing to an interface, and transmitting to another device. The providing the determined mechanical property may comprise presenting and/or displaying and/or communicating the determined mechanical property, e.g. to a user. The providing may be performed using at least one output unit 136. The output unit 136 may be or may comprise at least one interface configured for providing the determined mechanical property, e.g. to at least one user. The output unit 136 may comprise at least one display device.

The method for predicting the mechanical property may be a self-learning method. The method may be configured for learning with every repetition of the method and, in particular, to improve over time in the sense of providing an as far as possible reliable mechanical property. The method may comprise using at least one artificial intelligence (AI-) system. The method may comprise using at least one machine-learning tool, in particular a deep learning architecture. The method may be performed completely automatic. The complete automatization of the method may allow the AI-system to find optimal parameters and models on its own. Specifically, the method may be self-optimizing by setting its parameters iteratively to fulfill a pre-defined final goal without human interaction. To this end, a machine learning model is used. Based on observations the machine learning model facilitates the prediction of the mechanical property.

FIG. 2 shows a flowchart of an embodiment of a method computer implemented method for determining a layout of at least one composite element 110 according to the present invention. With respect to the description of the composite element 110 reference is made to FIG. 6. The method comprises the following method steps which, specifically, may be performed in the given order. Still, a different order is also possible. It is further possible to perform two or more of the method steps fully or partially simultaneously. Further, one or more or even all of the method steps may be performed once or may be performed repeatedly, such as repeated once or several times. Further, the method may comprise additional method steps which are not listed.

The method comprises the following steps:
i) (reference number 138) retrieving at least one target criterion for a target composite element;
ii) (reference number 140) predicting at least one mechanical property of a start composite element using a method according to the present invention for predicting at least one mechanical property, wherein properties of each of the single layers 112 of the start composite element are defined by the input parameter set;
iii) (reference number 142) at least one optimization step, wherein the optimization step comprises determining a target parameter set for the target composite element by comparing the determined mechanical property with the target criterion, wherein the target parameter is set by adapting the input parameter set depending on the comparison in case the target criterion is not fulfilled, or by setting the input parameter set as target parameter set in case the target criterion is fulfilled;
iv) (reference number 144) providing the determined target parameter set as layout for the composite element.

The layout may be or may comprise at least one configuration and/or properties of the elements of the composite element 110 such as shape of single nodes 116, position of nodes 116 within the single layer 112, position of edges 118 within the layer 112 and/or with respect to nodes 116, thickness of nodes 116, length of edges 118, thickness of edges 118, contact area 113 between single layers 112.

Retrieving the target criterion may comprise generating the target criterion and/or obtaining the target criterion from an arbitrary data source, such as from a data storage, from a network or from a further computer or computer system. The retrieving specifically may take place via at least one computer interface, in particular the communication interface 132, such as via a port such as a serial or parallel port. The retrieving may comprise several sub-steps, such as the sub-step of obtaining one or more items of primary information and generating secondary information by making use of the primary information, such as by applying one or more algorithms to the primary information, e.g. by using a processor.

The target criterion may refer to at least one criterion under which the optimization is performed. The target criterion may comprise at least one optimization goal and accuracy and/or precision. The target criterion may be pre-specified such as by at least one customer request. The target criterion may be at least one user's specification. The user may select the optimization goal and/or a desired accuracy and/or precision. The target criterion may comprise at least one value of a physical property selected from the group consisting of: solid volume fraction; relative stiffness; damping properties; characteristics of stress vs. strain curve; hardness; energy dissipation; tensile properties; properties under compression; properties under shear; properties under complex deformations; anisotropy; thermal extension. The target composite element may be a composite element 110 having the desired and/or required properties at least within tolerances.

The optimization step may comprises determining the target parameter set by applying an optimizing algorithm in terms of the target criterion on a trained machine-learning model. The machine-learning model may comprise one or more of: linear regression, logistic regression, random forest, naive Bayes classifications, nearest neighbors, neural networks, convolutional neural networks, generative adversarial networks, support vector machines, or gradient boosting algorithms or the like.

The method may comprise repeating steps i) to iv), wherein the determined target parameter set is used as input parameter set. The method may be a self-learning method. The method may comprise using at least one artificial intelligence (AI-) system. The method may comprise using at least one machine-learning tool, in particular a deep learning architecture. The method may be performed completely automatic. The complete automatization of the method may allow the AI-system to find the optimal layout on its own. Specifically, the method may be self-optimizing by setting its parameters iteratively to fulfill a pre-defined final goal without human interaction. To this end, a machine learning model is used. Based on observations the machine learning model facilitates the finding of a best or optimal layout.

The method further may comprise prototyping the target composite element having the layout determined in step iv). In particular, the prototype may be a first model of an element or object and may be used for testing and/or verification of at least one characteristic or specification of the element or object. Specifically, the prototype may be manufactured prior to a large-scale production process or a mass production process. A prototype may, for example, be produced or manufactured as a part of a development phase of the element or object, such as of the composite element 110. Thus, the prototyping of the composite element may specifically be performed before starting a large scale production process or manufacturing of the composite element 110.

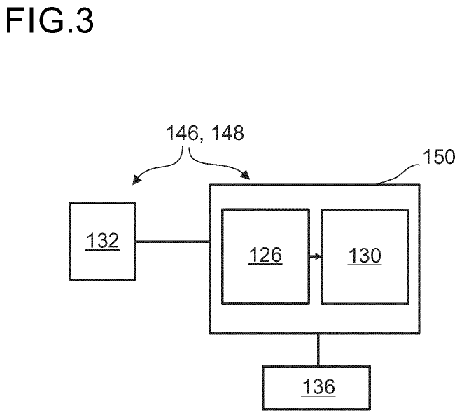

FIG. 3 shows an embodiment of an automated control system 146 and automated layout designing system 148 according to the present invention.

The control system 146 comprises
the at least one communication interface 132 configured for receiving at least one input parameter set comprising a plurality of parameters defining properties of each of the single layers 112;
the at least one design tool 126 configured for determining at least one geometric model of the composite element based on the input parameter set;
the at least one numerical simulation 130 configured for determining a mechanical property of the geometric model of the composite element, wherein the mechanical property comprises one or more of tension property, pressure property, shear property, temperature property and a combination thereof.

The control system 146 further may comprise the at least one output unit 136.

The layout designing system 148 comprises
the at least one communication interface 132 configured for retrieving at least one target criterion for a target composite element and for receiving at least one input parameter set comprising a plurality of parameters defining properties of each of the single layers 112;
the at least one material modelling tool 126 configured for determining at least one geometric model of the composite element from the input parameter set;
the at least one numerical simulation 130 configured for determining at least one mechanical property of the geometric model of the composite element, wherein the mechanical property comprises one or more of tension property, pressure property, shear property, temperature property and a combination thereof;
at least one processing unit 150 configured for performing at least one optimization step, wherein the optimization step comprises determining a target parameter set for the target composite element by comparing the determined mechanical property with the target criterion, wherein the target parameter is set by adapting the input parameter set depending on the comparison in case the target criterion is not fulfilled, or by setting the input parameter set as target parameter set in case the target criterion is fulfilled;
the at least one output unit 136 configured for providing the determined target parameter set as layout for the composite element.

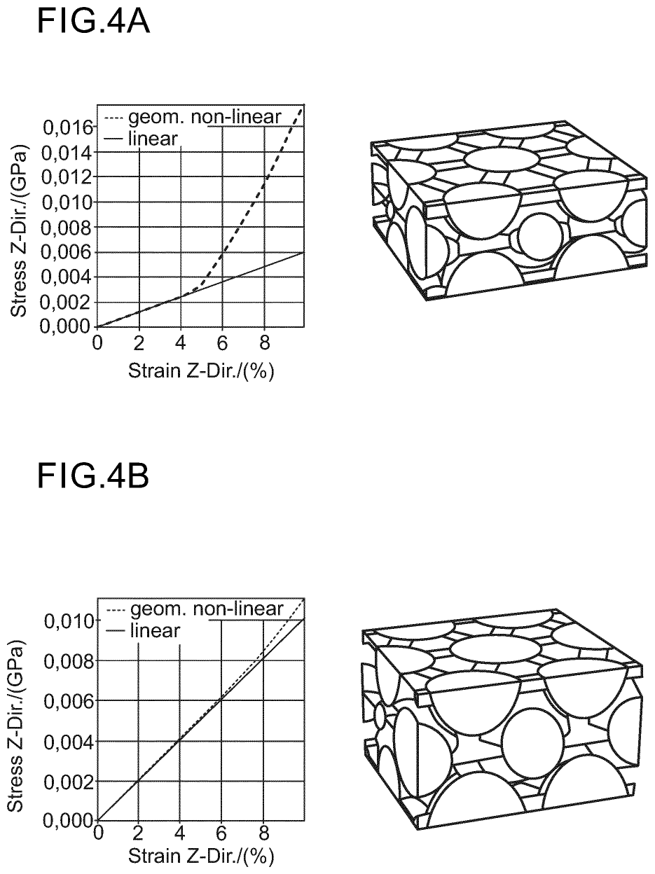

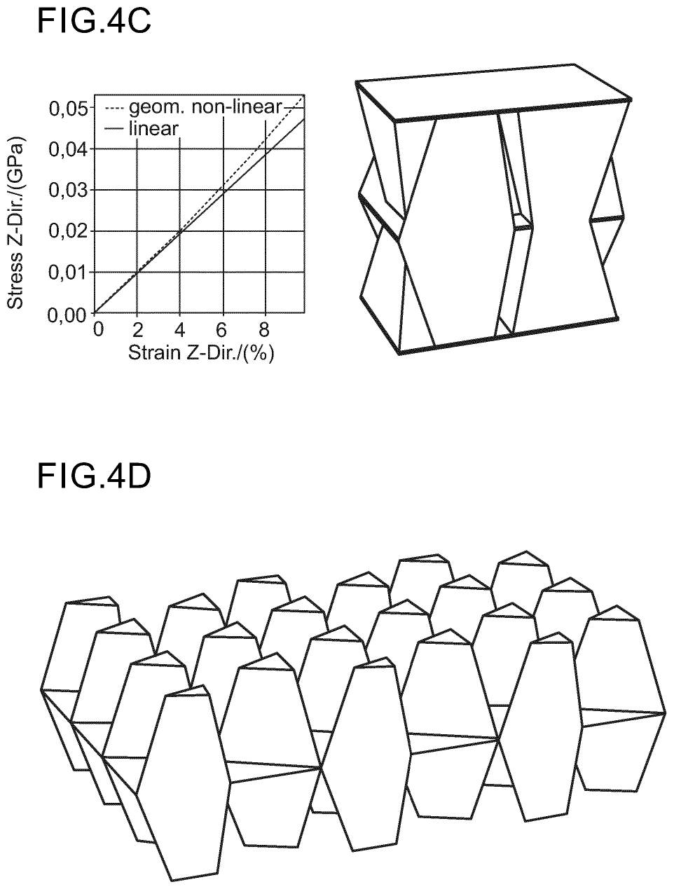

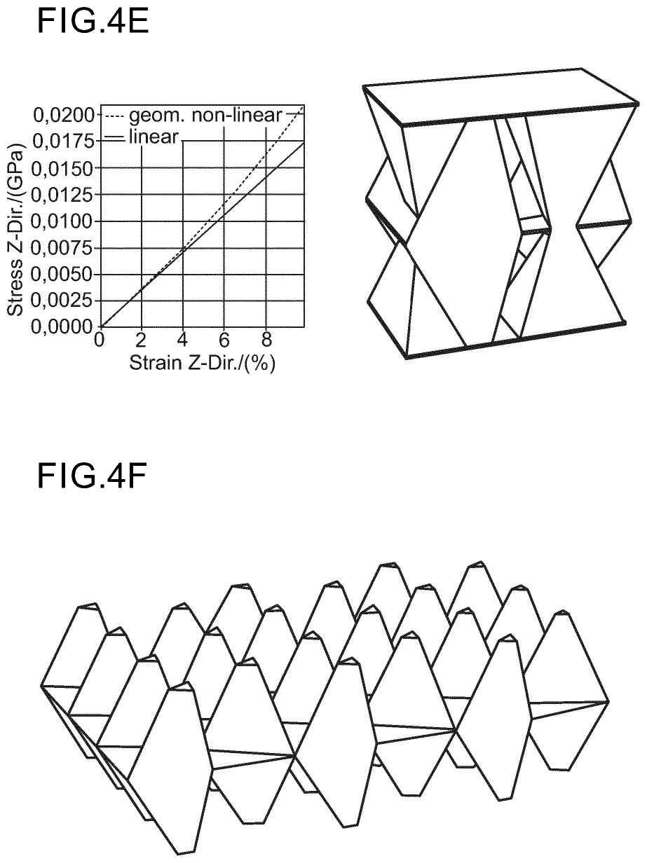

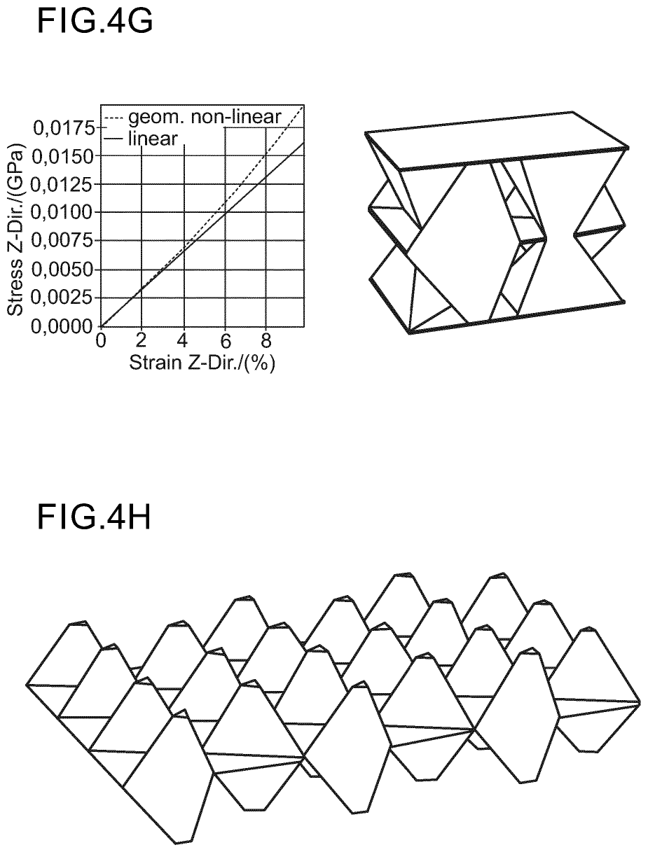

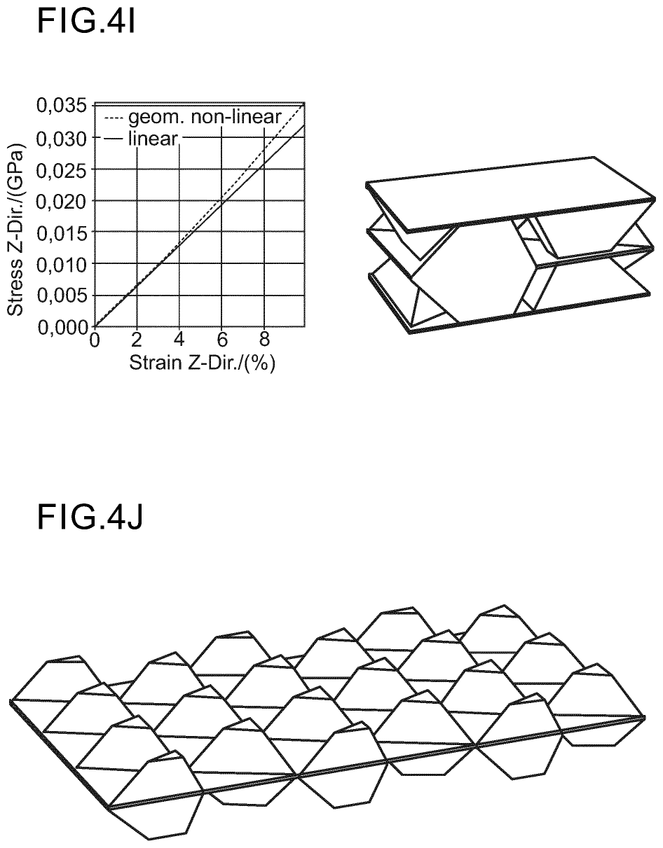

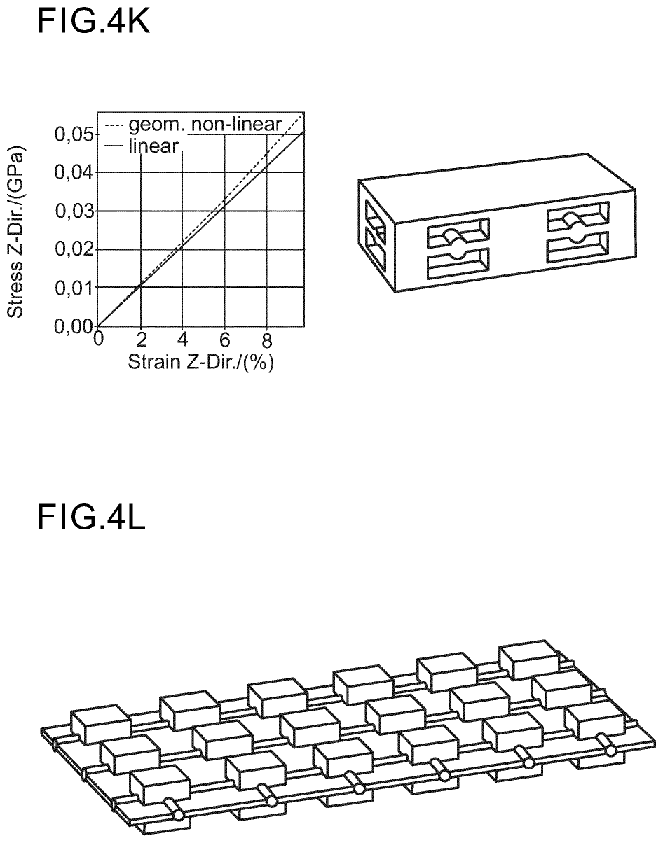

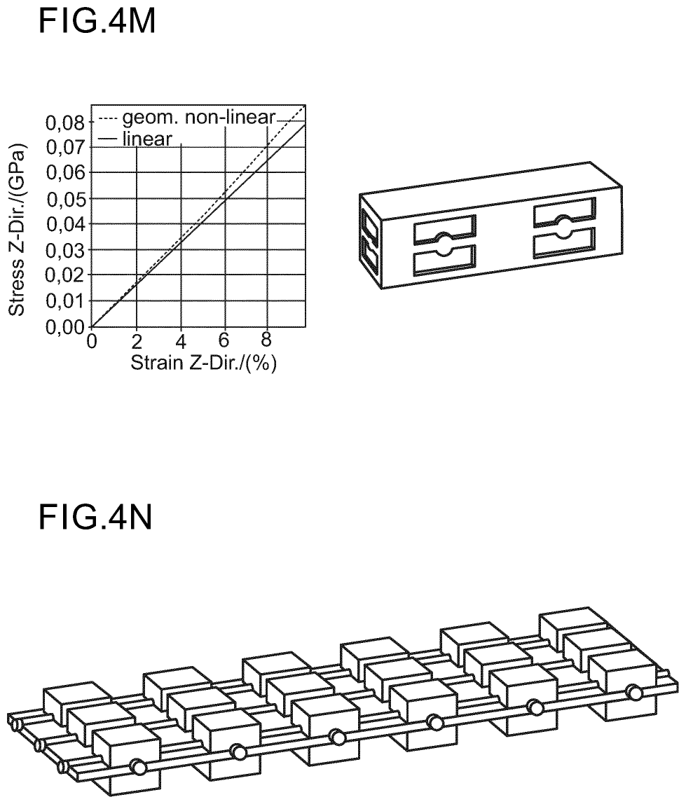

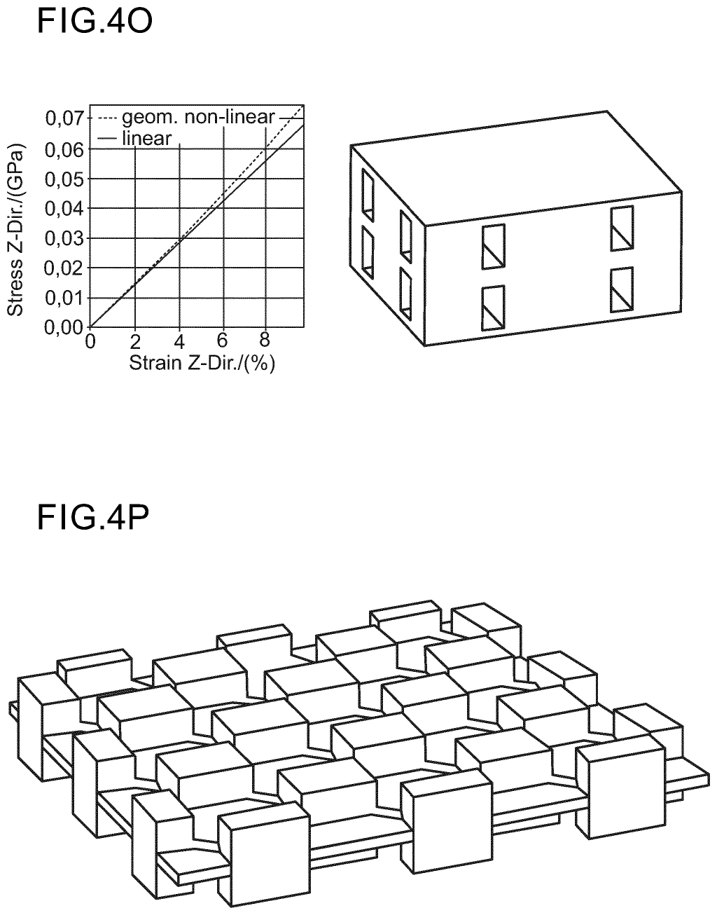

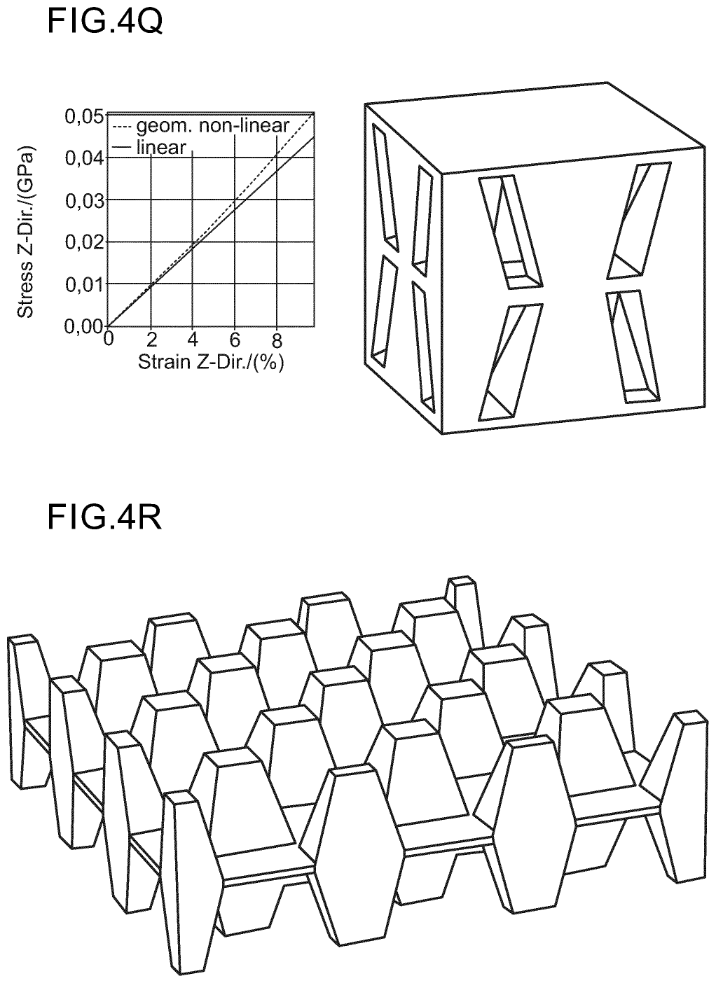

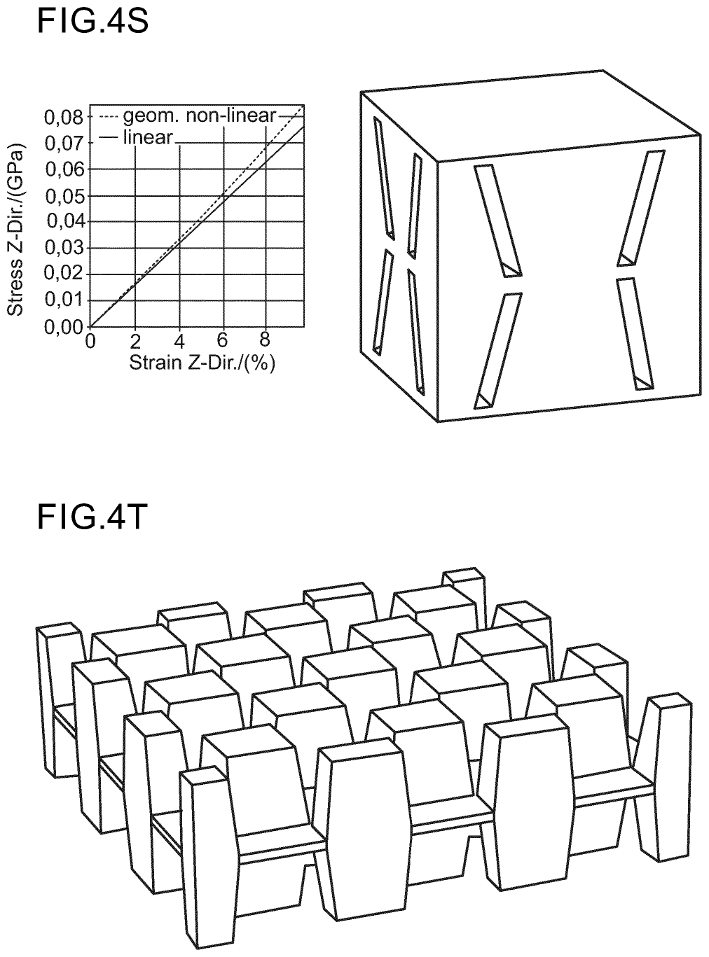

FIGS. 4A to 4T show embodiments of geometric model of the composite elements determined by using the design tool 126.

FIGS. 4A and 4B show volume elements of the composite element 110, wherein the nodes 116 are of spherical shape. Moreover, the predicted stress in z-direction vs strain in z-direction curves are shown, wherein the z-direction is from up to down in direction of gravity. Moreover, the curves for linear modelling and for non-linear modelling, denoted deformation, are shown. In FIG. 4A the edges 118 are smaller compared to the edges 116 of FIG. 4B. For the embodiment of FIG. 4A the solid volume fraction was determined by geometrical analysis to be 67.4% and the relative stiffness is 6.0% which was determined by using the numerical simulation 139. For the embodiment of FIG. 4B the solid volume fraction was determined by geometrical analysis to be 66.8% and the relative stiffness is 10.2% which was determined by using the numerical simulation 139.

FIGS. 4C to 4J show embodiments, wherein the nodes are of trigonal bipyramidal shape. Specifically, 4 embodiments are shown, wherein two parameters were adapted: the relation of width to height and the size of the plateau (contact area to next layer).

FIG. 4C shows a volume element of the composite element 110, wherein the nodes 116 are of bipyramidal shape. Moreover, the predicted stress in z-direction vs strain in z-direction curves are shown, wherein the z-direction is from up to down in direction of gravity. The curves for linear modelling and for non-linear modelling, denoted deformation, are shown. Moreover, in FIG. 4D a corresponding modelled layer 112 is depicted. For the embodiment of FIG. 4C the solid volume fraction was determined by geometrical analysis to be 60.0% and the relative stiffness is 48.2% which was determined by using the numerical simulation 139.

FIG. 4E shows a volume element of the composite element 110, wherein the nodes 116 are of bipyramidal shape. Moreover, the predicted stress in z-direction vs strain in z-direction curves are shown, wherein the z-direction is from up to down in direction of gravity. The curves for linear modelling and for non-linear modelling, denoted deformation, are shown. Moreover, in FIG. 4F a corresponding modelled layer 112 is depicted. In comparison to the embodiment of FIGS. 4C and 4D the pyramids are sharpener. Specifically, the pyramids have a smaller plateau on its top. For the embodiment of FIG. 4E the solid volume fraction was determined by geometrical analysis to be 43.1% and the relative stiffness is 17.6% which was determined by using the numerical simulation 139.

FIG. 4G shows a volume element of the composite element 110, wherein the nodes 116 are of bipyramidal shape. Moreover, the predicted stress in z-direction vs strain in z-direction curves are shown, wherein the z-direction is from up to down in direction of gravity. The curves for linear modelling and for non-linear modelling, denoted deformation, are shown. Moreover, in FIG. 4H a corresponding modelled layer 112 is depicted. In comparison to the embodiment of FIGS. 4E and 4F the pyramids have a reduced height. For the embodiment of FIG. 4G the solid volume fraction was determined by geometrical analysis to be 43.9% and the relative stiffness is 16.4% which was determined by using the numerical simulation 139.

FIG. 4I shows a volume element of the composite element 110, wherein the nodes 116 are of bipyramidal shape. Moreover, the predicted stress in z-direction vs strain in z-direction curves are shown, wherein the z-direction is from up to down in direction of gravity. The curves for linear modelling and for non-linear modelling, denoted deformation, are shown. Moreover, in FIG. 4J a corresponding modelled layer 112 is depicted. In comparison to the embodiment of FIGS. 4G and 4H the pyramids have a bigger plateau on its top. For the embodiment of FIG. 4I the solid volume fraction was determined by geometrical analysis to be 55.4% and the relative stiffness is 32.2% which was determined by using the numerical simulation 139.

FIGS. 4K to 4P show embodiments, wherein the nodes are of cubic shape. Specifically, three embodiments are shown, wherein two parameters were adapted: position of nodes and position of edges.

FIG. 4K shows a volume element of the composite element 110, wherein the nodes 116 are of cubic shape. Moreover, the predicted stress in z-direction vs strain in z-direction curves are shown, wherein the z-direction is from up to down in direction of gravity. The curves for linear modelling and for non-linear modelling, denoted deformation, are shown. Moreover, in FIG. 4L a corresponding modelled layer 112 is depicted. For the embodiment of FIG. 4K the solid volume fraction was determined by geometrical analysis to be 62.8% and the relative stiffness is 51.9% which was determined by using the numerical simulation 139.

FIG. 4M shows a volume element of the composite element 110, wherein the nodes 116 are of cubic shape. Moreover, the predicted stress in z-direction vs strain in z-direction curves are shown, wherein the z-direction is from up to down in direction of gravity. The curves for linear modelling and for non-linear modelling, denoted deformation, are shown. Moreover, in FIG. 4N a corresponding modelled layer 112 is depicted. In comparison to FIGS. 4K and 4L, in one direction edges 118 are shorter. For the embodiment of FIG. 4M the solid volume fraction was determined by geometrical analysis to be 86.2% and the relative stiffness is 81.5% which was determined by using the numerical simulation 139.

FIG. 4O shows a volume element of the composite element 110, wherein the nodes 116 are of cubic shape. Moreover, the predicted stress in z-direction vs strain in z-direction curves are shown, wherein the z-direction is from up to down in direction of gravity. The curves for linear modelling and for non-linear modelling, denoted deformation, are shown. Moreover, in FIG. 4P a corresponding modelled layer 112 is depicted. In comparison to FIGS. 4K and 4L, the nodes 116 are oriented non-parallel but with an angle with respect to a longitudinal extension of the layer 112. For the embodiment of FIG. 4O the solid volume fraction was determined by geometrical analysis to be 77.9% and the relative stiffness is 70.1% which was determined by using the numerical simulation 139.

FIGS. 4Q to 4T show embodiments, wherein the nodes are of quadratic bipyramidal shape. Specifically, 2 embodiments are shown, wherein the size of the plateau (contact area to next layer) was adapted.

FIG. 4Q shows a volume element of the composite element 110, wherein the nodes 116 are of quadratic bipyramidal shape and meet each other. Moreover, the predicted stress in z-direction vs strain in z-direction curves are shown, wherein the z-direction is from up to down in direction of gravity. The curves for linear modelling and for non-linear modelling, denoted deformation, are shown. Moreover, in FIG. 4R a corresponding modelled layer 112 is depicted. For the embodiment of FIG. 4Q the solid volume fraction was determined by geometrical analysis to be 61.1% and the relative stiffness is 45.5% which was determined by using the numerical simulation 139.

FIG. 4S shows a volume element of the composite element 110, wherein the nodes 116 are of quadratic bipyramidal shape and meet each other, the pyramids have a bigger Plateau on its top. Moreover, the predicted stress in z-direction vs strain in z-direction curves are shown, wherein the z-direction is from up to down in direction of gravity. The curves for linear modelling and for non-linear modelling, denoted deformation, are shown. Moreover, in FIG. 4T a corresponding modelled layer 112 is depicted. For the embodiment of FIG. 4S the solid volume fraction was determined by geometrical analysis to be 82.6% and the relative stiffness is 78.5% which was determined by using the numerical simulation 139.

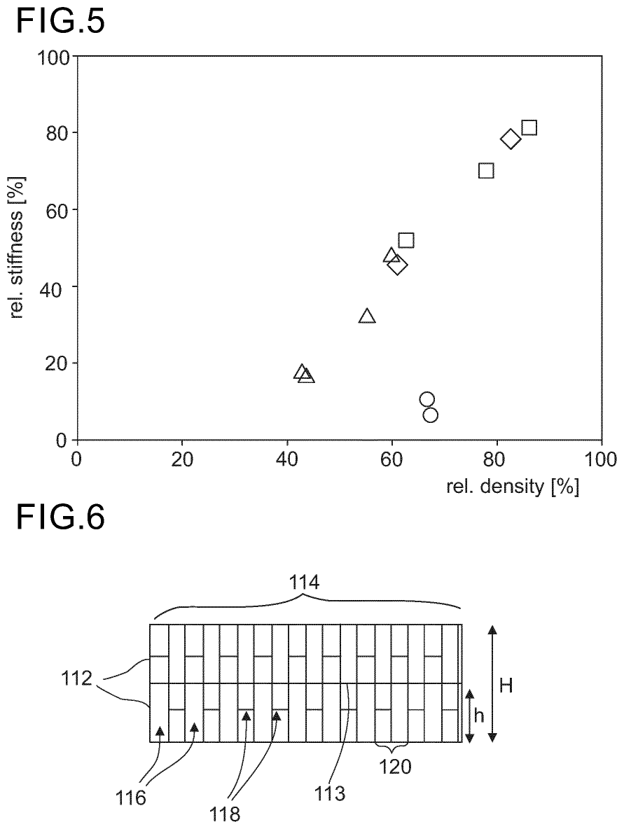

FIG. 5 shows a comparison of different layouts of composite elements 110, in particular relative density in % vs relative stiffness in %. Triangles are embodiments triagonal bi-pyramidal nodes, squares are cubic nodes, circles are spherical nodes, and quadratic bi-pyramidal nodes are shown as diamonds.

### LIST OF REFERENCE NUMBERS

110 composite element
112 layer
113 contact area
114 network
116 Node
118 edge
120 Repeating unit
122 providing at least one input parameter set
124 determining at least one geometric model of the composite element
126 design tool
128 determining at least one mechanical property
130 numerical simulation
132 communication interface
134 providing the determined mechanical property
136 output unit
138 retrieving at least one target criterion
140 predicting at least one mechanical property
142 optimization step
144 providing the determined target parameter set
146 control system
148 layout designing system
150 processing unit

1. A computer implemented method for predicting at least one mechanical property of at least one composite element comprising at least two layers, wherein each layer comprises a network having repeating units which comprise nodes and edges, wherein each layer has a volume, a longitudinal extension and a maximum height h vertical to the longitudinal extension and comprises a material with cellular structure, wherein the layers are stacked, wherein the method comprises:
a) providing at least one input parameter set, wherein the input parameter set comprises a plurality of parameters defining properties of each of the single layers;
d) determining at least one geometric model of the composite element based on the input parameter set using at least one design tool; and
b) determining at least one mechanical property of the geometric model of the composite element by using at least one numerical simulation, wherein the mechanical property comprises one or more selected from the group consisting of tension property, pressure property, shear property, temperature property, and a combination thereof.

2. The method according to claim 1, wherein the mechanical property is at least one property selected from the group consisting of solid volume fraction; relative stiffness; damping properties; characteristics of stress vs. strain curve; hardness; energy dissipation; tensile properties; properties under compression; properties under shear; properties under complex deformations; anisotropy; and thermal extension.

3. The method according to claim 1, wherein step b) comprises at least one geometric analysis, wherein the geometric analysis comprises determining packing density and/or layer distance.

4. The method according to claim 1, wherein the input parameter set comprises at least one parameter selected from the group consisting of shape of single nodes; position of nodes within the single layer; position of edges within the layer and/or with respect to nodes; thickness of nodes; length of edges; thickness of edges; and contact area between single layers.

5. The method according to claim 1, wherein the input parameter set comprises at least one parameter defining a stacking of the layers of the composite element.

6. The method according to claim 1, wherein the design tool comprises a computer-aided design (CAD) tool.

7. The method according to claim 1, wherein the numerical simulation is a Finite-Element-Method (FEM) simulation, wherein the FEM simulation is a voxel based FEM simulation.

8. The method according to claim 1, wherein the method comprises providing the determined mechanical property.

9. The method according to claim 1, wherein the providing the determined mechanical property comprises one or more of displaying, storing, providing to an interface, and transmitting to another device.

10. The method according to claim 1, wherein the method comprises controlling the at least one mechanical property of at least one composite element, wherein at least one process parameter for manufacturing the composite element is set to the determined mechanical properties and/or depending on the determined mechanical properties.

11. The method according to claim 1, wherein the method comprises controlling the at least one mechanical property of at least one composite element selected from the group consisting of a damping element, a mattress or part of a mattress, a furniture or flooring element, an element of automotive industry, and a body protector.

12. A computer program for predicting at least one mechanical property of at least one composite element, configured for causing a computer or a computer network to fully or partially perform the method according to claim 1, when executed on the computer or the computer network, wherein the computer program is configured to perform at least one of steps a) to c) of the method.

13. A computer implemented method for determining a layout of at least one composite element comprising at least two layers, wherein each layer comprises a network having repeating units which comprise nodes and edges, wherein each layer has a volume, a longitudinal extension and a maximum height h vertical to the longitudinal extension and comprises a material with cellular structure, wherein the layers are stacked, wherein the method comprises:
i) retrieving at least one target criterion for a target composite element;
ii) predicting at least one mechanical property of a start composite element using a method according to claim 1, wherein properties of each of the single layers of the start composite element are defined by the input parameter set;
iii) at least one optimization step, wherein the optimization step comprises determining a target parameter set for the target composite element by comparing the determined mechanical property with the target criterion, wherein the target parameter is set by adapting the input parameter set depending on the comparison in case the target criterion is not fulfilled, or by setting the input parameter set as target parameter set in case the target criterion is fulfilled: and
iv) providing the determined target parameter set as layout for the composite element.

14. The method according to claim 13, wherein the method comprises repeating steps i) to iv), wherein the determined target parameter set is used as input parameter set.

15. The method according to claim 13, wherein the target criterion comprises at least one value of a physical property selected from the group consisting of solid volume fraction; relative stiffness; damping properties; characteristics of stress vs. strain curve; hardness; energy dissipation; tensile properties; properties under compression; properties under shear; properties under complex deformations; anisotropy; and thermal extension.

16. The method according to claim 13, wherein the optimization step comprises determining the target parameter set by applying an optimizing algorithm in terms of the target criterion on a trained machine-learning model, wherein the machine-learning model comprises one or more selected from the group consisting of linear regression, logistic regression, random forest, naive Bayes classifications, nearest neighbors, neural networks, convolutional neural networks, generative adversarial networks, support vector machines, and gradient boosting algorithms.

17. The method according to claim 13, wherein the providing the determined target parameter set comprises one or more of displaying, storing, providing to an interface, and transmitting to another device.

18. The method according to claim 13, wherein the method further comprises prototyping the target composite element having the layout determined in step iv).

19. A computer program for determining a layout of at least one composite element, configured for causing a computer or a computer network to fully or partially perform the method according to claim 13, when executed on the computer or the computer network, wherein the computer program is configured to perform at least steps i) to iv) of the method.

20. An automated control system for predicting at least one mechanical property of at least one composite element comprising at least two layers, wherein each layer comprises a network having repeating units which comprise nodes and edges, wherein each layer has a volume, a longitudinal extension and a maximum height h vertical to the longitudinal extension and comprises a material with cellular structure, wherein the layers are stacked, wherein the control system comprises
at least one communication interface configured for receiving at least one input parameter set comprising a plurality of parameters defining properties of each of the single layers (112);
at least one design tool configured for determining at least one geometric model of the composite element based on the input parameter set; and
at least one numerical simulation configured for determining a mechanical property of the geometric model of the composite element, wherein the mechanical property comprises one or more of tension property selected from the group consisting of pressure property, shear property, temperature property, and a combination thereof.

21. The control system according to claim 20, wherein the control system is configured for performing the method according to claim 1.

22. The control system according to claim 20, wherein the control system comprises at least one output unit configured for providing the determined mechanical property.

23. The control system according to claim 20, wherein the providing the determined mechanical property comprises one or more step selected from the group consisting of displaying, storing, providing to an interface, and transmitting to another device.

24. The control system according to claim 20, wherein the control system is configured for controlling the at least one mechanical property of at least one composite element, wherein the control system is configured for setting at least one process parameter for manufacturing the composite element to the determined mechanical properties and/or depending on the determined mechanical properties.

25. The control system according to claim 20, wherein the control system is configured for the controlling the at least one mechanical property of at least one composite element selected from the group consisting of a damping element, a mattress or part of a mattress, a furniture or flooring element, an element of automotive industry, and a body protector.

26. An automated layout designing system for determining a layout of at least one composite element comprising at least two layers, wherein each layer comprises a network having repeating units which comprise nodes and edges, wherein each layer has a volume, a longitudinal extension and a maximum height h vertical to the longitudinal extension and comprises a material with cellular structure, wherein the layers are stacked, wherein the layout designing system comprises
at least one communication interface configured for retrieving at least one target criterion for a target composite element and for receiving at least one input parameter set comprising a plurality of parameters defining properties of each of the single layers;
at least one material modelling tool configured for determining at least one geometric model of the composite element from the input parameter set;
at least one numerical simulation configured for determining at least one mechanical property of the geometric model of the composite element, wherein the mechanical property comprises one or more selected from the group consisting of tension property, pressure property, shear property, temperature property, and a combination thereof;
at least one processing unit configured for performing at least one optimization step, wherein the optimization step comprises determining a target parameter set for the target composite element by comparing the determined mechanical property with the target criterion, wherein the target parameter is set by adapting the input parameter set depending on the comparison in case the target criterion is not fulfilled, or by setting the input parameter set as target parameter set in case the target criterion is fulfilled; and
at least one output unit configured for providing the determined target parameter set as layout for the composite element.

27. The layout designing system according to claim 26, wherein the layout designing system is configured for performing the method according to claim 13.

28. A method of using a control system according to claim 20, the method comprising using the control system for controlling mechanical properties of a composite element selected from the group consisting of a damping element, a mattress or part of a mattress, a furniture or flooring element, an element of automotive and a body protector.

29. A method of using a system according to claim 26, the method comprising using the system for designing a layout of a composite element selected from the group consisting of a damping element, a mattress or part of a mattress, a furniture or flooring element, an element of automotive industry, and a body protector.
